(19) United States
(12) Patent Application Publication
(10) Pub. No.: US 2022/0105446 A1
(43) Pub. Date: Apr. 7, 2022

(54) EXTRACTION SYSTEM

(71) Applicant: KABUSHIKI KAISHA KOBE SEIKO SHO (KOBE STEEL, LTD.), Hyogo (JP)

(72) Inventors: Akira MATSUOKA, Kobe-shi (JP); Koji NOISHIKI, Takasago-shi, Hyogo (JP)

(73) Assignee: KABUSHIKI KAISHA KOBE SEIKO SHO (KOBE STEEL, LTD.), Hyogo (JP)

(21) Appl. No.: 17/472,394

(22) Filed: Sep. 10, 2021

(30) Foreign Application Priority Data
Oct. 2, 2020 (JP) 2020-167650

(51) Int. Cl. B01D 11/04

(52) U.S. Cl. CPC B01D 11/0484; B01D 11/0496; B01D 11/0492; B01D 11/0453

(57) ABSTRACT

An extraction system includes an extractor that carries out an extraction treatment of bringing a raw material liquid into contact with an extraction liquid so that metal ions are extracted from the raw material liquid to migrate to the extraction liquid, a raw material liquid return path that leads the raw material liquid from a separator to a raw material liquid tank; and a raw material liquid pH regulator addition apparatus connected to a raw material liquid pH adjustment place that is one of the raw material liquid tank and the raw material liquid return path, the raw material liquid pH regulator addition apparatus configured to add a raw material liquid pH regulator to the raw material liquid, the raw material liquid pH regulator being a pH regulator that increases pH of the raw material liquid that have been decreased by the extraction treatment.

### TECHNICAL FIELD

The present invention relates to an extraction system.

### BACKGROUND ART

An extraction system has been known which extracts metal ions from a raw material liquid that is an aqueous solution containing the metal ions, using an extraction liquid. Japanese Patent No. 6205317 discloses an extraction apparatus as an example of such an extraction system.

The extraction apparatus disclosed in Japanese Patent No. 6205317 includes a plurality of extractors each of which extract metal ions from a raw material liquid, using an extraction liquid. The extractors are connected in series so that the raw material liquid flows therethrough in sequence. Specifically, the extractors each include an extractor body and a discharge header. The extractor body has an internal channel in which an extraction treatment is performed to cause the raw material liquid and the extraction liquid to circulate together in a state of being in contact with each other and, in the course of the circulation, extract metal ions from the raw material liquid and cause the metal ions to migrate to the extraction liquid. The discharge header is attached to the extractor body such that a mixture liquid of the raw material liquid and the extraction liquid that have been subjected to the extraction treatment is discharged from an outlet of the channel to a space in the discharge header. The mixture liquid discharged from the outlet of the channel is separated into the raw material liquid and the extraction liquid by a difference in specific gravity between both liquids in a space in the discharge header. The discharge header of an extractor located on the upstream side in the direction of flow of the raw material liquid, the extractor being one of the plurality of extractors, is connected to an extractor adjacent to and downstream of the extractor located on the upstream side, via a connection pipe. The raw material liquid separated in the space in the discharge header of the extractor on the upstream side flows to the extractor on the downstream side through the connection pipe.

In this extraction apparatus, pH of the raw material liquid is decreased by the extraction treatment in the channel of the extractor to deviate from an optimum pH that offers a fine extraction rate, and, consequently, the metal ion extraction rate of an extractor drops further as the extractor is located further downstream in the direction of flow of the raw material liquid among the plurality of extractors. To prevent this, a pH regulator is added to the raw material liquid in the connection pipe. This pH regulator causes a pH change in the raw material liquid, the pH change being reverse to a pH change caused in the raw material liquid by the extraction treatment.

The conventional extraction apparatus disclosed in Japanese Patent No. 6205317 has a problem that it is difficult to increase an extraction time in which the pH of the raw material liquid is close to the optimum pH that allows extraction of specific metal ions from the raw material liquid at a fine extraction rate while suppressing an increase in the size and configuration complexity of the extraction apparatus and to flexibly deal with a change in a metal ion concentration of the raw material liquid not subjected to the extraction treatment yet, the raw material liquid being supplied to the extraction system, and properly set an extraction time for completing extraction of metal ions from the raw material liquid.

Specifically, in the conventional extraction apparatus, the pH regulator is added to the raw material liquid flowing through the connection pipe between the extractor on the upstream side and the extractor on the downstream side, so that the pH of the raw material liquid having been decreased by the extraction treatment at the extractor on the upstream side is brought closer to the optimum pH. However, the extraction treatment with the pH of the raw material liquid adjusted by addition of the pH regulator being maintained is performed only at the beginning of the extraction treatment in the channel of the extractor on the downstream side. In the extraction apparatus as a whole, an attempt to increase the extraction time in which the pH of the raw material liquid is close to the optimum pH leaves no option but to increase the number of extractors and supply the pH regulator to each connection pipe through which the raw material liquid flows into each of the extractors. This raises a concern that the extraction apparatus may be increased in size and its configuration may become complicated.

According to the conventional extraction apparatus, an extraction time required by the extraction apparatus as a whole depends on the number of extractors included in the extraction apparatus. Therefore, there is a room for improvement of the extraction apparatus. For example, when a metal ion concentration of the raw material liquid not subjected to the extraction treatment yet, the raw material liquid being supplied to the extractor on the most upstream side of the extraction apparatus, changes, the change in the metal ion concentration of the raw material liquid is flexibly dealt with to allow properly setting an extraction time for completing extraction of metal ions from the raw material liquid.

### SUMMARY OF INVENTION

An object of the present invention is to provide an extraction system that solves the above-described problem.

Another object of the present invention is to provide an extraction system that increases an extraction time in which pH of a raw material liquid is close to an optimum pH to improve extraction efficiency while suppressing an increase in the size and configuration complexity of the extraction system and that flexibly deals with a change in a metal ion concentration of the raw material liquid not subjected to an extraction treatment yet to allow properly setting an extraction time for completing extraction of metal ions from the raw material liquid.

According to one aspect of the present invention, the extraction system extracts that causes an extraction liquid to extract metal ions from a raw material liquid that is an aqueous solution containing the metal ions. This extraction system includes: a raw material liquid tank holding the raw material liquid; an extraction liquid tank holding the extraction liquid; an extractor that is connected to the raw material liquid tank to allow the raw material liquid to be led from the raw material liquid tank into the extractor and that is connected to the extraction liquid tank to allow the extraction liquid to be led from the extraction liquid tank into the extractor, the extractor carrying out an extraction treatment of bringing the raw material liquid led in from the raw material liquid tank into contact with the extraction liquid led in from the extraction liquid tank so that the metal ions are extracted from the raw material liquid to migrate to the extraction liquid; a separator connected to the extractor so as to receive, from the extractor, a mixture liquid of the raw material liquid and the extraction liquid that have been subjected to the extraction treatment, the separator separating the received mixture liquid into the raw material liquid and the extraction liquid; a raw material liquid return path that connects the separator to the raw material liquid tank so as to lead the separated raw material liquid from the separator to the raw material liquid tank, the separated raw material liquid being the raw material liquid separated by the separator; an extraction liquid return path that connects the separator to the extraction liquid tank so as to lead the separated extraction liquid from the separator to the extraction liquid tank, the separated extraction liquid being the extraction liquid separated by the separator; and a raw material liquid pH regulator addition apparatus connected to a raw material liquid pH adjustment place that is one of the raw material liquid tank and the raw material liquid return path, the raw material liquid pH regulator addition apparatus configured to add a raw material liquid pH regulator to the raw material liquid in the raw material liquid pH adjustment place, the raw material liquid pH regulator being a pH regulator that increases pH of the raw material liquid, the pH having been decreased by the extraction treatment.

### BRIEF DESCRIPTION OF DRAWINGS

FIG. 1 is a schematic diagram of an extraction system according to a first embodiment of the present invention;

FIG. 2 is a schematic diagram of an extraction system according to a second embodiment of the present invention;

FIG. 3 is a schematic diagram of an extraction system according to a third embodiment of the present invention;

FIG. 4 is a schematic diagram of an extraction system according to a fourth embodiment of the present invention;

FIG. 5 is a schematic diagram of an extraction system according to a fifth embodiment of the present invention;

FIG. 6 is a schematic diagram of an extraction system according to a sixth embodiment of the present invention;

FIG. 7 is a schematic diagram of an extraction system according to a comparative example used in a simulation of an extraction treatment of extracting metal ions from a raw material liquid, the comparative example being used to examine an effect achieved by the present invention;

FIG. 8 is a chart showing a correlation between the number of times of the extraction treatment and pH of a raw material liquid and a correlation between the number of times of the extraction treatment and an extraction rate, the correlations being obtained from an example corresponding to the present invention through the simulation;

FIG. 9 is a chart showing a correlation between the number of times of the extraction treatment and the pH of the raw material liquid and a correlation between the number of times of the extraction treatment and the extraction rate, the correlations being obtained from the comparative example through the simulation;

FIG. 10 is a schematic diagram of an extraction system according to a first modification of the present invention;

FIG. 11 is a schematic diagram of an extraction system according to a second modification of the present invention;

FIG. 12 is a schematic diagram of an extraction system according to a third modification of the present invention;

FIG. 13 is a schematic diagram of an extraction system according to a fourth modification of the present invention; and

FIG. 14 is a schematic diagram of an extraction system according to a fifth modification of the present invention.

### DESCRIPTION OF EMBODIMENTS

Embodiments of the present invention will now be described with reference to the drawings.

### First Embodiment

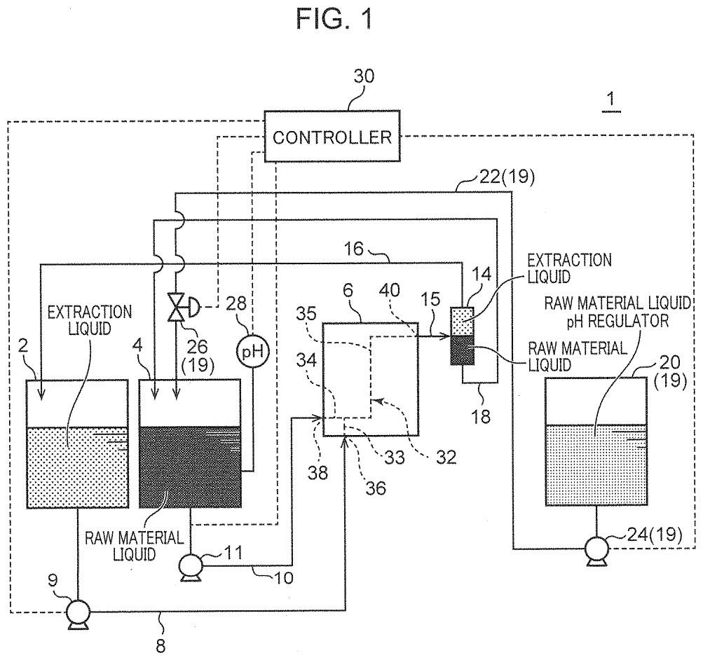

FIG. 1 depicts an overall configuration of an extraction system 1 according to a first embodiment of the present invention. The extraction system 1 according to the first embodiment carries out an extraction treatment of extracting metal ions of a specific type from a raw material liquid, which is an aqueous solution containing a plurality of types of metal ions, using an extraction liquid. The extraction liquid is incompatible with the raw material liquid, and is of an organic phase. The extraction liquid has a specific gravity smaller than the specific gravity of the raw material liquid. Examples of the metal ion of the specific type extracted by the extraction treatment vary. An extraction liquid appropriate for extracting the metal ion of the specific type, which is to be extracted, is selected as the extraction liquid for use in the extraction treatment. For example, when the metal ion of the specific type to be extracted, which are included in the raw material liquid, are nickel ions or cobalt ions, a liquid produced by diluting PC88A manufactured by DAIHACHI CHEMICAL INDUSTRY CO., LTD. with kerosene is used as the extraction liquid.

The extraction system 1 according to the first embodiment includes an extraction liquid tank 2, a raw material liquid tank 4, an extractor 6, an extraction liquid supply pipe 8, an extraction liquid feed pump 9, a raw material liquid supply pipe 10, a raw material liquid feed pump 11, a separator 14, a connection pipe 15, an extraction liquid return pipe 16, a raw material liquid return pipe 18, a raw material liquid pH regulator addition apparatus 19, a raw material liquid pH sensor 28, and a controller 30.

The extraction liquid tank 2 holds the extraction liquid. The extraction liquid tank 2 holds an unused extraction liquid, which is an extraction liquid not used for the extraction treatment yet, before the start of the extraction treatment (before the extraction system 1 starts operating). After the extraction treatment starts (after the extraction system 1 starts operating), a post-extraction extraction liquid, which is an extraction liquid having been subjected to the extraction treatment by the extractor 6 (which will be described later) and then separated from the raw material liquid by the separator 14, is led into the extraction liquid tank 2, which holds the post-extraction extraction liquid led thereto.

The raw material liquid tank 4 holds the raw material liquid. The raw material liquid tank 4 holds an untreated raw material liquid, which is a raw material liquid not subjected to the extraction treatment, before the start of the extraction treatment. After the extraction treatment is started, a raw material liquid having been subjected to the extraction treatment by the extractor 6 (which will be described later) and then separated from the extraction liquid by the separator 14 is led into the raw material liquid tank 4, which holds the raw material liquid led thereto. In the first embodiment, the raw material liquid tank 4 corresponds to a raw material liquid pH adjustment place according to the present invention.

The extractor 6 is connected to the raw material liquid tank 4 via the raw material liquid supply pipe 10 so that the raw material liquid from the raw material liquid tank 4 is led into the extractor 6, and is connected to the extraction liquid tank 2 via the extraction liquid supply pipe 8 so that the extraction liquid from the extraction liquid tank 2 is led into the extractor 6. The extractor 6 carries out the extraction treatment of bringing the raw material liquid led in from the raw material liquid tank 4 into contact with the extraction liquid led in from the extraction liquid tank 2, thereby extracting metal ions from the raw material liquid and causing the metal ions to migrate to the extraction liquid.

Specifically, the extractor 6 has a number of treatment channels 32 therein. Each treatment channel 32 causes the raw material liquid and the extraction liquid to flow such that the raw material liquid and the extraction liquid come in contact with each other to extract the metal ions from the raw material liquid and cause the metal ions to migrate to the extraction liquid. In FIG. 1, a number of treatment channels 32 in the extractor 6 are simply represented as one channel, and its shape is also represented in a simple form. The number, arrangement, and respective shapes of the treatment channels 32 provided in the extractor 6 are, therefore, determined arbitrarily in accordance with conditions for the extraction treatment.

Each treatment channel 32 is a so-called microchannel. Each treatment channel 32 includes an extraction liquid lead-in path 33 into which the extraction liquid is led, a raw material liquid lead-in path 34 into which the raw material liquid is led, and a treatment channel portion 35 which is connected to respective downstream ends of the extraction liquid lead-in path 33 and the raw material liquid lead-in path 34 so that the extraction liquid flows from the extraction liquid lead-in path 33 into the treatment channel portion 35 as the raw material liquid flows from the raw material liquid lead-in path 34 into the treatment channel portion 35 and in which the extraction liquid coming in from the extraction liquid lead-in path 33 and the raw material liquid coming in from the raw material liquid lead-in path 34 flow together in a state of being in contact with each other and the extraction treatment is performed.

The extractor 6 also has an extraction liquid inlet 36 connected to the extraction liquid lead-in paths 33 of all treatment channels 32 provided in the extractor 6, a raw material liquid inlet 38 connected to the raw material liquid lead-in paths 34 of all treatment channels 32, and an outlet 40 connected to downstream ends of the treatment channel portions 35 of all treatment channels 32. The extraction liquid inlet 36 is a portion that receives the extraction liquid supplied from the extraction liquid tank 2. The extraction liquid having passed through the extraction liquid inlet 36 branches into the extraction liquid lead-in paths 33 to flow therethrough. The raw material liquid inlet 38 is a portion that receives the raw material liquid supplied from the raw material liquid tank 4. The raw material liquid having passed through the raw material liquid inlet 38 branches into the raw material liquid lead-in paths 34 to flow therethrough. The outlet 40 is a portion that allows a mixture liquid of the extraction liquid and the raw material liquid flow out of the extractor 6, the extraction liquid and the raw material liquid having flowed through the treatment channel portion 35 of each treatment channel 32, thus having been subjected to the extraction treatment.

The extraction liquid supply pipe 8 connects the extraction liquid tank 2 to the extraction liquid inlet 36 so as to lead the extraction liquid held in the extraction liquid tank 2 to the extraction liquid inlet 36 of the extractor 6.

The extraction liquid feed pump 9 is provided on the extraction liquid supply pipe 8. When actuated, the extraction liquid feed pump 9 pumps the extraction liquid out of the extraction liquid tank 2 and sends the extraction liquid to the extraction liquid inlet 36 through the extraction liquid supply pipe 8.

The raw material liquid supply pipe 10 connects the raw material liquid tank 4 to the raw material liquid inlet 38 so as to lead the raw material liquid held in the raw material liquid tank 4 to the raw material liquid inlet 38 of the extractor 6.

The raw material liquid feed pump 11 is provided on the raw material liquid supply pipe 10. When actuated, the raw material liquid feed pump 11 pumps the raw material liquid out of the raw material liquid tank 4 and sends the raw material liquid to the raw material liquid inlet 38 through the raw material liquid supply pipe 10.

The separator 14 is a container that separates, into the raw material liquid and the extraction liquid, a mixture liquid of the raw material liquid and the extraction liquid, the raw material liquid having been subjected to the extraction treatment in the treatment channel portion 35 of each treatment channel 32 of the extractor 6 and the extraction liquid subjected to the extraction treatment in the treatment channel portion 35. Specifically, the separator 14 is connected to the outlet 40 of the extractor 6 via the connection pipe 15. The separator 14 receives the mixture liquid discharged from the outlet 40 of the extractor 6, through the connection pipe 15. The separator 14 temporarily holds the received mixture liquid, and phase-separates the mixture liquid vertically into the extraction liquid (light liquid) and the raw material liquid (heavy liquid) by a difference in specific gravity between both liquids. The separated raw material liquid (heavy liquid) precipitates at the bottom of the separator 14, and the separated extraction liquid (light liquid) settles on the precipitated raw material liquid.

The extraction liquid return pipe 16 connects an area of separator 14 that holds the separated extraction liquid to the extraction liquid tank 2 so as to lead the extraction liquid separated by the separator 14, from the separator 14 to the extraction liquid tank 2. The extraction liquid return pipe 16 is an example of an extraction liquid return path according to the present invention.

The raw material liquid return pipe 18 connects an area of separator 14 that holds the separated raw material liquid to the raw material liquid tank 4 so as to lead the raw material liquid separated by the separator 14, from the separator 14 to the raw material liquid tank 4. The raw material liquid return pipe 18 is an example of a raw material liquid return path according to the present invention.

The raw material liquid pH regulator addition apparatus 19 is connected to the raw material liquid tank 4, and adds a raw material liquid pH regulator to the raw material liquid in the raw material liquid tank 4, the raw material liquid pH regulator increasing pH of the raw material liquid that has been decreased by the extraction treatment at the extractor 6. The raw material liquid pH regulator is a liquid substance according to the first embodiment. The raw material liquid pH regulator is an alkaline aqueous solution, e.g., a sodium hydroxide aqueous solution that increases the pH of the raw material liquid. The raw material liquid pH regulator addition apparatus 19 has a raw material liquid pH regulator reservoir unit 20, a raw material liquid pH regulator supply pipe 22, a raw material liquid pH regulator supply pump 24, and a raw material liquid pH regulator flow rate adjusting valve 26.

The raw material liquid pH regulator reservoir unit 20 is a tank that holds the pH regulator which is a liquid substance. For simpler description, the raw material liquid pH regulator reservoir unit 20 will hereinafter be referred to as a reservoir unit 20.

The raw material liquid pH regulator supply pipe 22 connects the reservoir unit 20 to the raw material liquid tank 4 so as to lead the raw material liquid pH regulator held in the reservoir unit 20 to the raw material liquid tank 4. For simpler description, the raw material liquid pH regulator supply pipe 22 will hereinafter be referred to as a pH regulator supply pipe 22.

The raw material liquid pH regulator supply pump 24 is provided on the pH regulator supply pipe 22. For simpler description, the raw material liquid pH regulator supply pump 24 will hereinafter be referred to as a pH regulator supply pump 24. The pH regulator supply pump 24 sends the raw material liquid pH regulator held in the reservoir unit 20, from the reservoir unit 20 to the raw material liquid tank 4 through the pH regulator supply pipe 22.

On the pH regulator supply pipe 22, the raw material liquid pH regulator flow rate adjusting valve 26 is located downstream of the pH regulator supply pump 24 in the direction of flow of the raw material liquid pH regulator in the pH regulator supply pipe 22. For simpler description, the raw material liquid pH regulator flow rate adjusting valve 26 will hereinafter be referred to as a flow rate adjusting valve 26. The flow rate adjusting valve 26 is an example of a raw material liquid pH regulator addition adjusting unit according to the present invention. The flow rate adjusting valve 26 can adjust an amount of addition of the raw material liquid pH regulator, which is added from the reservoir unit 20 to the raw material liquid in the raw material liquid tank 4, to any given amount of addition. Specifically, the flow rate adjusting valve 26 is capable of changing its degree of opening. The flow rate adjusting valve 26 regulates the flow rate of the pH regulator, which flows from the reservoir unit 20 through the pH regulator supply pipe 22 to the raw material liquid tank 4, to a flow rate corresponding to the degree of opening of the flow rate adjusting valve 26, thereby adjusting an amount of addition of the pH regulator, which is added to the raw material liquid in the raw material liquid tank 4, to any given amount of addition.

The raw material liquid pH sensor 28 is connected to the raw material liquid tank 4. The raw material liquid pH sensor 28 successively detects the pH of the raw material liquid in the raw material liquid tank 4, and successively transmits data of a detected pH value of the raw material liquid, the pH value being the detected pH of the raw material liquid, to the controller 30.

The controller 30 acquires data of the detected pH value of the raw material liquid successively transmitted from the raw material liquid pH sensor 28, and based on the acquired detected pH value of the raw material liquid, causes the flow rate adjusting valve 26 to adjust the flow rate of the raw material liquid pH regulator flowing from the reservoir unit 20 through the pH regulator supply pipe 22 to the raw material liquid tank 4. Specifically, the controller 30 adjusts the degree of opening of the flow rate adjusting valve 26 so that the acquired detected pH value of the raw material liquid approaches a raw material liquid pH optimum value set in advance, thereby causing the flow rate adjusting valve 26 to adjust the flow rate of the raw material liquid pH regulator. The raw material liquid pH optimum value corresponds to a raw material liquid optimum pH representing the pH of the raw material liquid that is optimum to the extraction treatment of extracting metal ions from the raw material liquid at the extractor 6. The raw material liquid optimum pH is the pH at which an extraction rate of metal ions of a specific type, which are be extracted, among multiple types of metal ions in the raw material liquid is high while extraction rates of metal ions of other types are low, that is, the pH at which a high extraction rate and high selectivity of metal ions of the specific type are obtained. In addition to control of the flow rate adjusting valve 26 as described above, the controller 30 controls also operations of the extraction liquid feed pump 9, the raw material liquid feed pump 11, and the pH regulator supply pump 24. Specific details of control carried out by the controller 30 will be described in the following description of an extraction method.

An extraction method by the extraction system 1 according to the first embodiment will then be described.

First, before the start of the extraction treatment in the extraction system 1 (before the start of operation of the extraction system 1), the extraction liquid tank 2 is filled with an unused extraction liquid and the raw material liquid tank 4 is filled with an untreated raw material liquid. The reservoir unit 20 is filled with the raw material liquid pH regulator.

Thereafter, the extraction treatment in the extraction system 1 is started. Specifically, the controller 30 actuates the extraction liquid feed pump 9, which then sends the unused extraction liquid from the extraction liquid tank 2 to the extraction liquid inlet 36 of the extractor 6 through the extraction liquid supply pipe 8. At the same time, the controller 30 actuates the raw material liquid feed pump 11, which then sends the untreated raw material liquid from the raw material liquid tank 4 to the raw material liquid inlet 38 of the extractor 6 through the raw material liquid supply pipe 10.

The extraction liquid sent to the extraction liquid inlet 36 flows into the extraction liquid lead-in path 33 of each treatment channel 32. The raw material liquid sent to the raw material liquid inlet 38 flows into the raw material liquid lead-in path 34 of each treatment channel 32. At each treatment channel 32, the extraction liquid flows through the extraction liquid lead-in path 33 into the treatment channel portion 35 as the raw material liquid flows through the raw material liquid lead-in path 34 into the treatment channel portion 35, and consequently the extraction liquid and the raw material liquid flow through the treatment channel portion 35 in a state of being in contact with each other. In the process of the extraction liquid and raw material liquid flowing together through the treatment channel portion 35, the metal ions of the specific type are extracted from the raw material liquid and migrate to the extraction liquid, i.e., the extraction treatment is performed. Then, a mixture liquid of the extraction liquid and the raw material liquid that have been subjected to the extraction treatment flows out of the outlet 40 of the extractor 6 and flows through the connection pipe 15 into the separator 14.

The mixture liquid led into the separator 14 stays in the separator 14, and is phase-separated into the extraction liquid (light liquid) and the raw material liquid (heavy liquid) vertically by a difference in specific gravity between both liquids. The extraction liquid separated in the separator 14 flows out of the separator 14 and flows through the extraction liquid return pipe 16 into the extraction liquid tank 2, that is, led into the extraction liquid tank 2. The raw material liquid separated in the separator 14 flows out of the separator 14 and flows through the raw material liquid return pipe 18 into the raw material liquid tank 4, that is, led into the raw material liquid tank 4. The extraction liquid led into the extraction liquid tank 2 is sent again from the extraction liquid tank 2 to the extraction liquid inlet 36 of the extractor 6 through the extraction liquid supply pipe 8, while the raw material liquid led into the raw material liquid tank 4 is sent again from the raw material liquid tank 4 to the raw material liquid inlet 38 of the extractor 6 through the raw material liquid supply pipe 10. In this manner, as the extraction liquid and the raw material liquid are circulated, the extraction treatment in the treatment channel portion 35 of each treatment channel 32 in the extractor 6 is performed repeatedly.

Extraction of the metal ions of the specific type from the raw material liquid by the extraction treatment leads to a drop in the pH of the raw material liquid. To deal with this, according to the extraction system 1 of the first embodiment, the raw material liquid pH regulator addition apparatus 19 adds the raw material liquid pH regulator to the raw material liquid in the raw material liquid tank 4, thereby increasing the pH of the raw material liquid, the pH having been decreased by extraction of the metal ions of the specific type, to bring the pH of the raw material liquid closer to the raw material liquid optimum pH.

Specifically, the controller 30 actuates the pH regulator supply pump 24, which then sends the raw material liquid pH regulator from the reservoir unit 20 to the raw material liquid tank 4 through the pH regulator supply pipe 22. The raw material liquid pH regulator is thus added to the raw material liquid in the raw material liquid tank 4. As a result of addition of the raw material liquid pH regulator to the raw material liquid in the raw material liquid tank 4, the pH of the raw material liquid that has been decreased by the extraction rises and approaches the raw material liquid optimum pH.

Based on a detected pH value of the raw material liquid, the detected pH value being the pH value of the raw material liquid in the raw material liquid tank 4 detected by the raw material liquid pH sensor 28, the controller 30 then causes the flow rate adjusting valve 26 to adjust the inflow of the raw material liquid pH regulator from the pH regulator supply pipe 22 to the raw material liquid tank 4, thereby adjusting an amount of addition of the raw material liquid pH regulator to the raw material liquid in the raw material liquid tank 4.

Specifically, the raw material liquid pH sensor 28 successively detects the pH of the raw material liquid in the raw material liquid tank 4, and successively transmits data of the detected pH value of the raw material liquid, the detected pH value being the detected pH, to the controller 30. The controller 30 acquires data of the detected pH value of the raw material liquid successively transmitted from the raw material liquid pH sensor 28, and calculates a necessary variation in the amount of addition of the raw material liquid pH regulator to the raw material liquid in the raw material liquid tank 4, the variation being necessary for matching the acquired detected pH value of the raw material liquid to the raw material liquid pH optimum value corresponding to the raw material liquid optimum pH, that is, specifically, calculates a necessary variation in the inflow of the raw material liquid pH regulator from the pH regulator supply pipe 22 to the raw material liquid tank 4. More specifically, the controller 30 first calculates a difference between the raw material liquid pH optimum value and the acquired detected pH value of the raw material liquid. The controller 30 stores therein a correlation between a variation in the inflow of the raw material liquid pH regulator to the raw material liquid tank 4 and a variation in the pH of the raw material liquid in the raw material liquid tank 4, the correlation being derived in advance. The controller 30 defines the calculated difference between the raw material liquid pH optimum value and the detected pH value of the raw material liquid, as the variation in the pH, and based on the correlation, calculates a variation in the inflow of the raw material liquid pH regulator to the raw material liquid tank 4, the variation corresponding to the difference defined as the variation in the pH. The controller 30 then causes the flow rate adjusting valve 26 to change its degree of opening in such a way as to achieve the calculated variation in the inflow of the raw material liquid pH regulator to the raw material liquid tank 4, thus causing the flow rate adjusting valve 26 to adjust the inflow of the raw material liquid pH regulator to the raw material liquid tank 4. The controller 30 successively carries out this control of the flow rate adjusting valve 26, i.e., control of causing the flow rate adjusting valve 26 to adjust the inflow of the raw material liquid pH regulator to the raw material liquid tank 4, based on the detected pH value of the raw material liquid that the controller 30 successively acquires from the raw material liquid pH sensor 28.

The extraction treatment, which is repeatedly performed in the treatment channel 32 in the extractor 6 as the extraction liquid and the raw material liquid are circulated, is continued until extraction of the metal ions from the raw material liquid by the circulating extraction liquid reaches extraction equilibrium. At a point of time at which the extraction reaches the extraction equilibrium, the controller 30 stops the extraction liquid feed pump 9, the raw material liquid feed pump 11, and the pH regulator supply pump 24 from operating. The point of time at which the extraction equilibrium is reached is set based on, for example, an elapsed time from the start of the extraction treatment (start of circulation of the extraction liquid and the raw material liquid), the elapsed time being examined in advance. After the controller 30 stops the extraction liquid feed pump 9, the raw material liquid feed pump 11, and the pH regulator supply pump 24, the extraction liquid having reached the extraction equilibrium in the extraction liquid tank 2 is replaced with an unused extraction liquid. After the replacement, the controller 30 restarts the extraction liquid feed pump 9, the raw material liquid feed pump 11, and the pH regulator supply pump 24, which resumes the extraction treatment in the extraction system 1. Subsequently, the extraction treatment is performed until extraction of metal ions from the raw material liquid is completed while the above replacement of the extraction liquid having reached its extraction equilibrium is carried out a desired number of times.

In the extraction system 1 according to the first embodiment, the raw material liquid is circulated such that the raw material liquid coming out of the raw material liquid tank 4 flows through the raw material liquid supply pipe 10, the extractor 6, the connection pipe 15, the separator 14, and the raw material liquid return pipe 18 and finally returns to the raw material liquid tank 4, while the extraction liquid is circulated such that the extraction liquid coming out of the extraction liquid tank 2 flows through the extraction liquid supply pipe 8, the extractor 6, the connection pipe 15, the separator 14, and the extraction liquid return pipe 16 and finally returns to the extraction liquid tank 2. As the raw material liquid and the extraction liquid circulate in this manner, the extractor 6 solely carries out the extraction treatment of extracting the metal ions from the raw material liquid repeatedly. In addition, according to this extraction system 1, every time the raw material liquid circulates in such a way as to return to the raw material liquid tank 4, as described above, the raw material liquid pH regulator addition apparatus 19 adds the raw material liquid pH regulator to the raw material liquid in the raw material liquid tank 4 to bring the pH of the raw material liquid closer to the raw material liquid optimum pH. Therefore, the extraction system 1 according to the first embodiment can improve extraction efficiency by increasing an extraction time in which the pH of the raw material liquid is close to the raw material liquid optimum pH in the extraction system 1 as a whole, while suppressing an increase in the size and configuration complexity of the extraction system 1 that results from an increase in the number of the extractors.

In the extraction system 1 according to the first embodiment, when the concentration of the metal ions of the specific type to be extracted, the metal ions being in the raw material liquid not subjected to the extraction treatment yet, is high, the number of times of circulation of the raw material liquid and the extraction liquid is increased to increase the number of times of the extraction treatments at the extractor 6. By this approach, a total extraction time in the extraction system 1 can be set to a proper extraction time within which extraction of the metal ions of the specific type from the raw material liquid is completed. When the concentration of the metal ions of the specific type in the raw material liquid not subjected to the extraction treatment yet is low, on the other hand, the number of times of circulation of the raw material liquid and the extraction liquid is reduced to reduce the number of times of the extraction treatments in the extractor 6. By this approach, the total extraction time in the extraction system 1 can be set to the proper extraction time within which extraction of the metal ions of the specific type from the raw material liquid is completed. Hence, in the extraction system 1 according to the first embodiment, properly changing the number of times of circulation of the raw material liquid and the extraction liquid allows flexibly dealing with changes in the concentration of the metal ions of the specific type in the raw material liquid not subjected to the extraction treatment yet, thus allowing setting a proper extraction time for completing extraction of the metal ions of the specific type from the raw material liquid.

### Second Embodiment

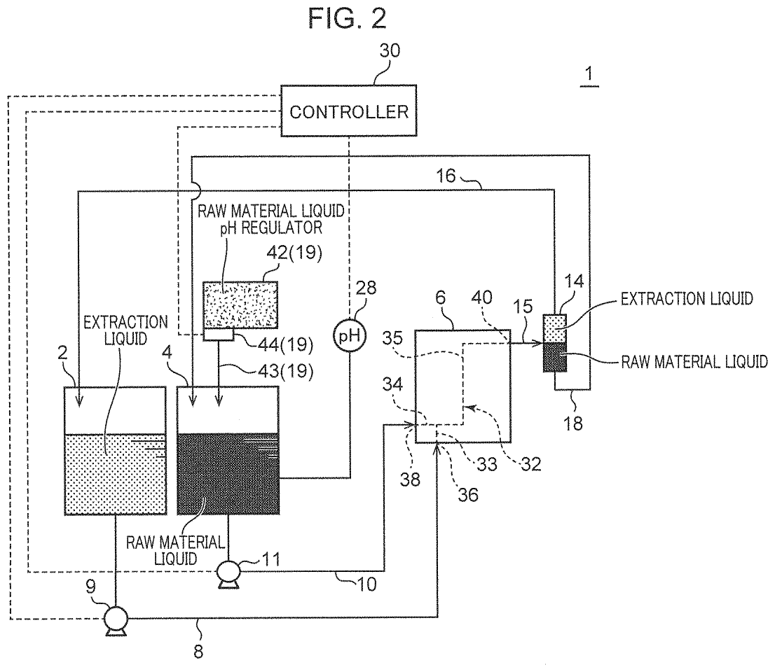

An extraction system 1 according to a second embodiment of the present invention will hereinafter be described with reference to FIG. 2.

The extraction system 1 according to the second embodiment is different from the extraction system 1 according to the first embodiment only in the configuration of the raw material liquid pH regulator addition apparatus 19. In the extraction system 1 according to the second embodiment, the raw material liquid pH regulator addition apparatus 19 adds a raw material liquid pH regulator of a solid substance to the raw material liquid in the raw material liquid tank 4 in order to bring the pH of the raw material liquid, which has been decreased by the extraction treatment at the extractor 6, closer to the raw material liquid optimum pH.

Specifically, the raw material liquid pH regulator addition apparatus 19 of the extraction system 1 according to the second embodiment includes a raw material liquid pH regulator reservoir unit 42, a raw material liquid pH regulator guide 43, and a raw material liquid pH regulator addition adjusting unit 44.

The raw material liquid pH regulator reservoir unit 42 is a container that holds the raw material liquid pH regulator of a solid substance. For simpler description, the raw material liquid pH regulator reservoir unit 42 will hereinafter be referred to as a reservoir unit 42. The raw material liquid pH regulator of a solid substance in the second embodiment is an alkaline substance, e.g., sodium hydroxide soluble in the raw material liquid, which is an aqueous solution containing metal ions, and the solid substance refers to grains, powder, or flakes of a solid substance. The reservoir unit 42 is disposed above the raw material liquid tank 4. The reservoir unit 42 has a discharge port (not illustrated) on its bottom, the discharge port discharging the raw material liquid pH regulator held in the reservoir unit 42. The raw material liquid pH regulator held in the reservoir unit 42 flows downward by its own weight through the discharge port of the reservoir unit 42 and is therefore discharged therefrom.

The raw material liquid pH regulator guide 43 is connected to the discharge port of the reservoir unit 42, and is connected to the raw material liquid tank 4 so as to lead the raw material liquid pH regulator discharged from the discharge port into the raw material liquid tank 4. For simpler description, the raw material liquid pH regulator guide 43 will hereinafter be referred to as a guide 43.

The raw material liquid pH regulator addition adjusting unit 44 adjusts an amount of addition of the raw material liquid pH regulator of a solid substance, which is added from the reservoir unit 42 to the raw material liquid in the raw material liquid tank 4, to any given amount of addition. For simpler description, the raw material liquid pH regulator addition adjusting unit 44 will hereinafter be referred to as an addition adjusting unit 44. The addition adjusting unit 44 is attached to the discharge port of the reservoir unit 42 so that the addition adjusting unit 44 can change the opening area of the discharge port. The addition adjusting unit 44 changes the opening area of the discharge port of the reservoir unit 42, thereby adjusting the amount of addition of the raw material liquid pH regulator of a solid substance, which comes out of the reservoir unit 42 through the discharge port to be added to the raw material liquid in the raw material liquid tank 4.

In the extraction system 1 according to the second embodiment, the controller 30 acquires data of the detected pH value of the raw material liquid successively transmitted from the raw material liquid pH sensor 28, and based on the acquired detected pH value of the raw material liquid, causes the addition adjusting unit 44 to adjust an amount of input of the raw material liquid pH regulator of a solid substance, which is inputted from the reservoir unit 42 through the discharge port to the raw material liquid tank 4. Specifically, the controller 30 causes the addition adjusting unit 44 to adjust the opening area of the discharge port of the reservoir unit 42 so that the acquired detected pH value of the raw material liquid approaches the raw material liquid pH optimum value set in advance, thus causing the addition adjusting unit 44 to adjust the amount of input of the raw material liquid pH regulator of a solid substance to the raw material liquid tank 4.

The configuration of the extraction system 1 according to the second embodiment is similar to that of the extraction system 1 according to the first embodiment, except for the above-described constituent elements.

An extraction method by the extraction system 1 according to the second embodiment will then be described.

The extraction method according to the second embodiment is different from the extraction method according to the first embodiment in that the raw material liquid pH regulator of a solid substance is added from the raw material liquid pH regulator addition apparatus 19 to the raw material liquid in the raw material liquid tank 4 and that the controller 30 causes the addition adjusting unit 44 to adjust the amount of addition of the raw material liquid pH regulator of a solid substance by adjusting the opening area of the discharge port of the reservoir unit 42.

Specifically, the controller 30 acquires data of the detected pH value of the raw material liquid successively transmitted from the raw material liquid pH sensor 28, and successively calculates a variation in the amount of addition of the raw material liquid pH regulator of a solid substance to the raw material liquid in the raw material liquid tank 4, the variation being necessary for matching the acquired detected pH value of the raw material liquid to the raw material liquid pH optimum value corresponding to the raw material liquid optimum pH, that is, specifically, successively calculates a variation in the amount of input of the raw material liquid pH regulator of a solid substance, which is inputted from the reservoir unit 42 to the raw material liquid tank 4.

More specifically, the controller 30 first calculates a difference between the raw material liquid pH optimum value and the acquired detected pH value of the raw material liquid. The controller 30 stores therein a correlation between a variation in the amount of input of the raw material liquid pH regulator of a solid substance to the raw material liquid tank 4 (weight or volume of the raw material liquid pH regulator) and a variation in the pH of the raw material liquid in the raw material liquid tank 4, the correlation being derived in advance. The controller 30 defines the calculated difference between the raw material liquid pH optimum value and the detected pH value of the raw material liquid, as the variation in the pH, and based on the correlation, calculates a variation in the amount of input of the raw material liquid pH regulator of a solid substance to the raw material liquid tank 4, the variation corresponding to the difference defined as the variation in the pH. The controller 30 then causes the addition adjusting unit 44 to change the opening area of the discharge port of the reservoir unit 42 in such a way as to achieve the calculated variation in the amount of input of the raw material liquid pH regulator of a solid substance, thus causing the addition adjusting unit 44 to adjust the amount of input of the raw material liquid pH regulator of a solid substance, which is inputted through the discharge port to the raw material liquid tank 4. The controller 30 successively carries out this control of the addition adjusting unit 44, based on the detected pH value of the raw material liquid that the controller 30 successively acquires from the raw material liquid pH sensor 28.

Other processes of the extraction method according to the second embodiment are similar to those of the extraction method according to the first embodiment.

The second embodiment offers the same effect as the first embodiment offers, and offers an additional effect that after completion of extraction of the metal ions, the treatment channel 32 in the extractor 6 being clogged with the raw material liquid pH regulator of a solid substance is prevented as the amount of the raw material liquid discarded as a waste liquid is reduced.

Specifically, in the second embodiment, the raw material liquid pH regulator of a solid substance is added to the raw material liquid to increase the pH of the raw material liquid, which has been decreased by the extraction treatment at the extractor 6, and bring the pH closer to the raw material liquid optimum pH. Because of this process, compared to a case of adding the raw material liquid pH regulator of a liquid substance to the raw material liquid, an increase in the volume of the raw material liquid resulting from addition of raw material liquid pH regulator thereto can be suppressed. When the raw material liquid is discarded as a waste liquid after completion of extraction of the metal ions, according to the second embodiment, an increase in the volume of the raw material liquid resulting from addition of the raw material liquid pH regulator thereto can be suppressed, as described above. Therefore, the amount of the raw material liquid discarded as the waste liquid can be reduced.

In a conventional multi-stage extraction apparatus, the pH regulator is added to the raw material liquid in a connection pipe connecting an extractor on the upstream side to an extractor on the downstream side. When the pH regulator is a solid substance, therefore, the pH regulator flows through the connection pipe into the treatment channel of the extractor on the downstream side before dissolving in the raw material liquid, which consequently raises a concern that the pH regulator of a solid substance may clog the treatment channel of the extractor on the downstream side. In the second embodiment, in contrast, the raw material liquid pH regulator of a solid substance is added from the raw material liquid pH regulator addition apparatus 19 to the raw material liquid held in the raw material liquid tank 4. This raw material liquid pH regulator dissolves in the raw material liquid during a period in which the raw material liquid stays in the raw material liquid tank 4 or during a later period in which the raw material liquid flows from the raw material liquid tank 4 through the raw material liquid supply pipe 10 to reach the extractor 6. Hence the treatment channel 32 in the extractor 6 being clogged with the raw material liquid pH regulator of a solid substance is prevented.

### Third Embodiment

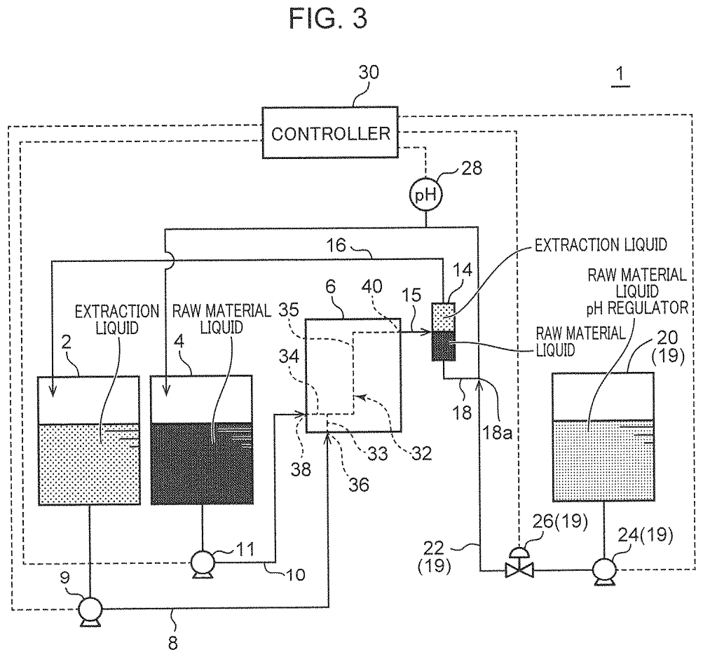

An extraction system 1 according to a third embodiment of the present invention will hereinafter be described with reference to FIG. 3.

In the extraction system 1 according to the third embodiment, the raw material liquid pH regulator addition apparatus 19 is connected to the raw material liquid return pipe 18, and the raw material liquid pH regulator of a liquid substance is added to the raw material liquid in the raw material liquid return pipe 18.

Specifically, in the extraction system 1 according to the third embodiment, the pH regulator supply pipe 22 of the raw material liquid pH regulator addition apparatus 19 connects the reservoir unit 20 to the raw material liquid return pipe 18 so as to lead the raw material liquid pH regulator of a liquid substance held in the reservoir unit 20 to the raw material liquid return pipe 18. Through this pH regulator supply pipe 22, the raw material liquid pH regulator of a liquid substance flowing out of the reservoir unit 20 is added to the raw material liquid in the raw material liquid return pipe 18. The raw material liquid return pipe 18 has a pH regulator addition point 18a, which is connected to the pH regulator supply pipe 22 and serves as a point at which the raw material liquid pH regulator addition apparatus 19 adds the raw material liquid pH regulator to the raw material liquid in the raw material liquid return pipe 18.

In the extraction system 1 according to the third embodiment, the raw material liquid pH sensor 28 is connected to the raw material liquid return pipe 18. The raw material liquid pH sensor 28 detects pH of the raw material liquid in the raw material liquid return pipe 18. More specifically, the raw material liquid pH sensor 28 is connected to a point on the raw material liquid return pipe 18, the point being downstream of the pH regulator addition point 18a in the direction of flow of the raw material liquid in the raw material liquid return pipe 18, that is, a point on the raw material liquid return pipe 18, the point being between the pH regulator addition point 18a and the raw material liquid tank 4, and detects the pH of the raw material liquid at that point. Based on the detected pH value of the raw material liquid at the point downstream of the pH regulator addition point 18a, the pH value being detected by the raw material liquid pH sensor 28, the controller 30 causes the flow rate adjusting valve 26 to adjust the inflow of the raw material liquid pH regulator of a liquid substance from the pH regulator supply pipe 22 to the pH regulator addition point 18a.

The configuration of the extraction system 1 according to the third embodiment is similar to that of the extraction system 1 according to the first embodiment, except for the above-described constituent elements.

An extraction method by the extraction system 1 according to the third embodiment will then be described.

According to the extraction method of the third embodiment, in a process in which, following the extraction treatment at the extractor 6, the raw material liquid separated from the extraction liquid by the separator 14 flows from the separator 14 toward the raw material liquid tank 4 through the raw material liquid return pipe 18, the raw material liquid pH regulator addition apparatus 19 adds the raw material liquid pH regulator of a liquid substance to the raw material liquid at the pH regulator addition point 18a.

The raw material liquid pH sensor 28 successively detects the pH of the raw material liquid at the point on the raw material liquid return pipe 18, the point being downstream of the pH regulator addition point 18a in the direction of flow of the raw material liquid in the raw material liquid return pipe 18. Based on the detected pH value of the raw material liquid, the pH value being detected by the raw material liquid pH sensor 28, the controller 30 causes the flow rate adjusting valve 26 to adjust the inflow of the raw material liquid pH regulator from the pH regulator supply pipe 22 to the raw material liquid return pipe 18.

In controlling the flow rate adjusting valve 26, the controller 30 successively calculates a necessary variation in the amount of addition of the raw material liquid pH regulator to the raw material liquid in the raw material liquid return pipe 18, the variation being necessary for matching the detected pH value of the raw material liquid at the point downstream of the pH regulator addition point 18a, the pH value being detected successively by the raw material liquid pH sensor 28, to the raw material liquid pH optimum value corresponding to the raw material liquid optimum pH, that is, successively calculates a necessary variation in the inflow of the raw material liquid pH regulator from the pH regulator supply pipe 22 to the pH regulator addition point 18a.

Specifically, the controller 30 stores therein a correlation between a variation in the inflow of the raw material liquid pH regulator of a liquid substance to the raw material liquid return pipe 18 and a variation in the pH of the raw material liquid in the raw material liquid return pipe 18, the correlation being derived in advance. The controller 30 calculates a difference between the raw material liquid pH optimum value and the detected pH value of the raw material liquid acquired from the raw material liquid pH sensor 28, defines the calculated difference as the variation in the pH, and based on the correlation, calculates a variation in the inflow of the raw material liquid pH regulator of a solid substance to the raw material liquid return pipe 18, the variation corresponding to the difference defined as the variation in the pH. The controller 30 then causes the flow rate adjusting valve 26 to change its degree of opening in such a way as to achieve the calculated variation in the inflow of the raw material liquid pH regulator of a liquid substance, thus causing the flow rate adjusting valve 26 to adjust the inflow of the raw material liquid pH regulator of a liquid substance to the raw material liquid return pipe 18. The controller 30 successively carries out this control of the flow rate adjusting valve 26, i.e., control of causing the flow rate adjusting valve 26 to adjust the inflow of the raw material liquid pH regulator to the raw material liquid return pipe 18, based on the detected pH value of the raw material liquid that the controller 30 successively acquires from the raw material liquid pH sensor 28.

Other processes of the extraction method according to the third embodiment are similar to those of the extraction method according to the first embodiment.

The third embodiment offers the same effects as the first embodiment offers, and additionally offers the following effects.

In the third embodiment, the raw material liquid pH sensor 28 detects the pH of the raw material liquid in the raw material liquid return pipe 18. Therefore, compared to the case of detecting the pH of the raw material liquid in the raw material liquid tank 4, the raw material liquid pH sensor 28 detects the pH of the raw material liquid that more directly reflects a drop in the pH of the raw material liquid that is caused by the extraction treatment at the extractor 6. The controller 30 can therefore cause the flow rate adjusting valve 26 to adjust the inflow of the raw material liquid pH regulator to the raw material liquid return pipe 18, based on the detected pH value of the raw material liquid that more directly reflects a drop in the pH of the raw material liquid that is caused by the extraction treatment at the extractor 6. Therefore, the pH of the raw material liquid that has been decreased by the extraction treatment can be brought closer more quickly to the raw material liquid optimum pH.

In the third embodiment, the raw material liquid pH sensor 28 detects the pH of the raw material liquid at the point on the raw material liquid return pipe 18, the point being downstream of the pH regulator addition point 18a. The controller 30 therefore causes the flow rate adjusting valve 26 to adjust the inflow of the raw material liquid pH regulator to the raw material liquid return pipe 18, based on the detected pH value of the raw material liquid to which the raw material liquid pH regulator has already been added at the pH regulator addition point 18a. This allows reducing a gap between a necessary variation in the amount of addition of the raw material liquid pH regulator, the variation being calculated by the controller 30 based on the pH value of the raw material liquid that is detected by the raw material liquid pH sensor 28, that is, a variation in the inflow of the raw material liquid pH regulator to the raw material liquid return pipe 18, the variation being necessary for matching the detected pH value of the raw material liquid to the raw material liquid pH optimum value, and a variation in the actual inflow of the raw material liquid pH regulator to the raw material liquid return pipe 18, the actual inflow being adjusted by the flow rate adjusting valve 26. Therefore, the pH of the raw material liquid that has been decreased by the extraction treatment at the extractor 6 can be adjusted more accurately to the raw material liquid optimum pH.

### Fourth Embodiment

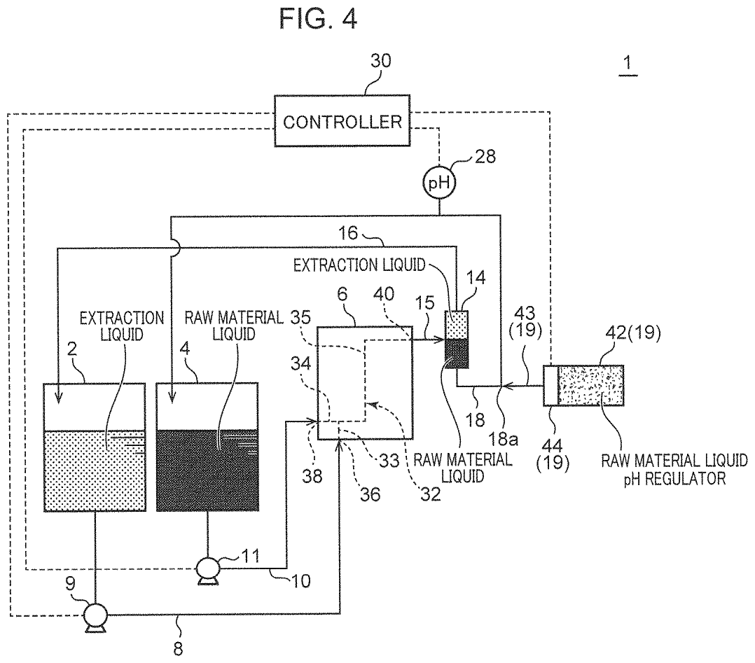

An extraction system 1 according to a fourth embodiment of the present invention will hereinafter be described with reference to FIG. 4.

The extraction system 1 according to the fourth embodiment is different from the extraction system 1 according to the third embodiment only in the configuration of the raw material liquid pH regulator addition apparatus 19. In the extraction system 1 according to the fourth embodiment, the raw material liquid pH regulator addition apparatus 19 adds the raw material liquid pH regulator of a solid substance to the raw material liquid flowing in the raw material liquid return pipe 18, in order to bring the pH of the raw material liquid, which has been decreased by the extraction treatment at the extractor 6, closer to the raw material liquid optimum pH. This raw material liquid pH regulator of a solid substance added by the raw material liquid pH regulator addition apparatus 19 is the same as the raw material liquid pH regulator of a solid substance added by the raw material liquid pH regulator addition apparatus 19 to the raw material liquid tank 4 in the second embodiment.

The raw material liquid pH regulator addition apparatus 19 of the extraction system 1 according to the fourth embodiment includes the reservoir unit 42, the guide 43, and the addition adjusting unit 44. These reservoir unit 42, guide 43, and addition adjusting unit 44 are the same as the reservoir unit 42, guide 43, and addition adjusting unit 44 of the raw material liquid pH regulator addition apparatus 19 in the second embodiment. It should be noted, however, that in the fourth embodiment, the guide 43 is connected to the raw material liquid return pipe 18. The raw material liquid pH regulator of a solid substance discharged from the discharge port of the reservoir unit 20 flows through the guide 43 and is added to the raw material liquid in the raw material liquid return pipe 18.

In the fourth embodiment, the pH regulator addition point 18a of the raw material liquid return pipe 18 is connected to the guide 43 of the raw material liquid pH regulator addition apparatus 19, and serves as a point at which the raw material liquid pH regulator addition apparatus 19 adds the raw material liquid pH regulator of a solid substance to the raw material liquid in the raw material liquid return pipe 18. FIG. 4 shows the reservoir unit 42 located by the side of the pH regulator addition point 18a, but the reservoir unit 42 is actually disposed above the pH regulator addition point 18a so that the pH regulator falls by its own weight from the discharge port of the reservoir unit 42 and is supplied to the pH regulator addition point 18a.

In the extraction system 1 according to the fourth embodiment, based on the detected pH value of the raw material liquid, the pH value being detected by the raw material liquid pH sensor 28, the controller 30 causes the addition adjusting unit 44 to adjust an amount of input of the raw material liquid pH regulator of a solid substance, which is inputted from the reservoir unit 42 to the pH regulator addition point 18a of the raw material liquid return pipe 18, that is, to adjust the amount of discharge of the raw material liquid pH regulator, which is discharged from the reservoir unit 42 through its discharge port, thereby adjusting the amount of addition of the raw material liquid pH regulator to the raw material liquid in the raw material liquid return pipe 18.

The configuration of the extraction system 1 according to the fourth embodiment is similar to that of the extraction system 1 according to the third embodiment, except for the above-described constituent elements.

An extraction method by the extraction system 1 according to the fourth embodiment will then be described.

According to the extraction method of the fourth embodiment, in the process in which, following the extraction treatment at the extractor 6, the raw material liquid separated from the extraction liquid by the separator 14 flows from the separator 14 toward the raw material liquid tank 4 through the raw material liquid return pipe 18, the raw material liquid pH regulator addition apparatus 19 adds the raw material liquid pH regulator of a solid substance to the raw material liquid at the pH regulator addition point 18a.

The raw material liquid pH sensor 28 successively detects the pH of the raw material liquid at a point on the raw material liquid return pipe 18, the point being downstream of the pH regulator addition point 18a in the direction of flow of the raw material liquid in the raw material liquid return pipe 18. Based on the detected pH value of the raw material liquid, the pH value being detected by the raw material liquid pH sensor 28, the controller 30 causes the addition adjusting unit 44 to adjust the amount of input of the raw material liquid pH regulator of a solid substance, which is inputted from the reservoir unit 42 to the raw material liquid return pipe 18.

In controlling the addition adjusting unit 44, the controller 30 successively calculates a necessary variation in the amount of addition of the raw material liquid pH regulator of a solid substance to the raw material liquid in the raw material liquid return pipe 18, the variation being necessary for matching the detected pH value of the raw material liquid at the point downstream of the pH regulator addition point 18a, the pH value being detected successively by the raw material liquid pH sensor 28, to the raw material liquid pH optimum value corresponding to the raw material liquid optimum pH, that is, specifically, successively calculates a necessary variation in the amount of input of the raw material liquid pH regulator of a solid substance, which is inputted from the reservoir unit 42 to the pH regulator addition point 18a.

Specifically, the controller 30 stores therein a correlation between a variation in the amount of input of the raw material liquid pH regulator of a solid substance to the raw material liquid return pipe 18 and a variation in the pH of the raw material liquid in the raw material liquid return pipe 18, the correlation being derived in advance. The controller 30 calculates a difference between the raw material liquid pH optimum value and the detected pH value of the raw material liquid acquired from the raw material liquid pH sensor 28, defines the calculated difference as the variation in the pH, and based on the correlation, calculates a variation in the amount of input of the raw material liquid pH regulator of a solid substance to the raw material liquid return pipe 18, the variation corresponding to the difference defined as the variation in the pH. The controller 30 then causes the addition adjusting unit 44 to change the opening area of the discharge port of the reservoir unit 42 in such a way as to achieve the calculated variation in the amount of input of the raw material liquid pH regulator of a solid substance, thus causing the addition adjusting unit 44 to adjust the amount of input of the raw material liquid pH regulator of a solid substance, which is inputted through the discharge port to the pH regulator addition point 18a of the raw material liquid return pipe 18. The controller 30 successively carries out this control of the addition adjusting unit 44, based on the detected pH value of the raw material liquid that the controller 30 successively acquires from the raw material liquid pH sensor 28.

Other processes of the extraction method according to the fourth embodiment are similar to those of the extraction methods according to the first and third embodiments.

The fourth embodiment offers the same effects as the first embodiment offers, and offers also effects that the pH of the raw material liquid, which has been decreased by the extraction treatment at the extractor 6, can be brought closer more quickly to the optimum pH and that the pH of the raw material liquid can be adjusted more accurately to the optimum pH, which effects are the same as the effects the third embodiment offers.

The fourth embodiment further offers an effect that after completion of extraction of the metal ions, the treatment channel 32 in the extractor 6 being clogged with the raw material liquid pH regulator of a solid substance is prevented as the amount of the raw material liquid discarded as a waste liquid is reduced, which effect is the same as the effect the second embodiment offers. Specifically, in the fourth embodiment, the raw material liquid pH regulator of a solid substance is added to the raw material liquid to bring the pH of the raw material liquid, which has been decreased by the extraction treatment at the extractor 6, closer to the optimum pH. Because of this process, compared to the case of adding the raw material liquid pH regulator of a liquid substance to the raw material liquid, the amount of the raw material liquid (total amount of the raw material liquid including the pH regulator) at a point of time of completing extraction of the metal ions can be reduced, so that the amount of the raw material liquid discarded as a waste liquid can be reduced. In addition, according to the fourth embodiment, because the raw material liquid pH regulator of a solid substance is added to the raw material liquid at the pH regulator addition point 18a far distant from the extractor 6 in the direction of flow of the raw material liquid in the raw material liquid circulation path in the extraction system 1, the raw material liquid pH regulator of a solid substance dissolves in the raw material liquid before the raw material liquid containing the added raw material liquid pH regulator reaches the extractor 6. Hence the treatment channel 32 in the extractor 6 being clogged with the raw material liquid pH regulator of a solid substance is prevented.

### Fifth Embodiment

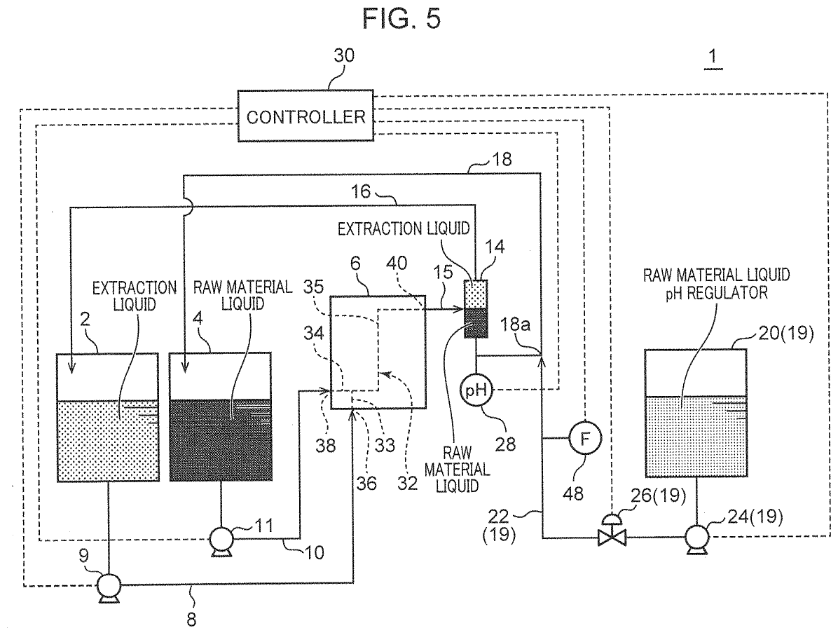

An extraction system 1 according to a fifth embodiment of the present invention will hereinafter be described with reference to FIG. 5.

In the extraction system 1 according to the fifth embodiment, as in the third embodiment, the raw material liquid pH regulator addition apparatus 19 adds the raw material liquid pH regulator of a liquid substance to the raw material liquid in the raw material liquid return pipe 18, and the controller 30 causes the flow rate adjusting valve 26 of the raw material liquid pH regulator addition apparatus 19 to adjust the amount of addition of the raw material liquid pH regulator to the raw material liquid in the raw material liquid return pipe 18. It should be noted, however, that in the extraction system 1 according to the fifth embodiment, the raw material liquid pH sensor 28 detects the pH of the raw material liquid at a point on the raw material liquid return pipe 18, the point being upstream of the pH regulator addition point 18a in the direction of flow of the raw material liquid in the raw material liquid return pipe 18. The controller 30 causes the flow rate adjusting valve 26 to adjust a flow rate of addition of the raw material liquid pH regulator to the raw material liquid in the raw material liquid return pipe 18, based on the detected pH value of the raw material liquid, the pH value being detected by the raw material liquid pH sensor 28, and on a measurement value of the flow rate of addition of the raw material liquid pH regulator to the raw material liquid in the raw material liquid return pipe 18, the measurement value being measured by a flowmeter 48.

Specifically, the extraction system 1 according to the fifth embodiment includes the flowmeter 48 that measures the flow rate of the raw material liquid pH regulator flowing through the pH regulator supply pipe 22 toward the pH regulator addition point 18a. The flow rate of the raw material liquid pH regulator is an index value for the amount of addition of the raw material liquid pH regulator, which is added from the reservoir unit 42 to the raw material liquid in the raw material liquid return pipe 18, and is an example of a raw material liquid pH regulator index value according to the present invention. The flowmeter 48 is an example of a raw material liquid pH regulator index value detector according to the present invention. The flowmeter 48 is connected to a point on the pH regulator supply pipe 22, the point being downstream of the pH regulator supply pump 24 in the direction of flow of the raw material liquid pH regulator in the pH regulator supply pipe 22, and successively measures the flow rate of the raw material liquid pH regulator at that point. The flowmeter 48 successively transmits data of a measurement value of the measured flow rate of the raw material liquid pH regulator, to the controller 30.

In the extraction system 1 according to the fifth embodiment, the raw material liquid pH sensor 28 is connected to a point on the raw material liquid return pipe 18, the point being upstream of the pH regulator addition point 18a in the direction of flow of the raw material liquid in the raw material liquid return pipe 18, that is, a point on the raw material liquid return pipe 18, the point being between the separator 14 and the pH regulator addition point 18a, and successively detects the pH of the raw material liquid at that point.

Based on the detected pH value of the raw material liquid at the point upstream of the pH regulator addition point 18a of the raw material liquid return pipe 18, the pH value being detected by the raw material liquid pH sensor 28, and on a measurement value of the flow rate of the raw material liquid pH regulator, the measurement value being measured by the flowmeter 48, the controller 30 causes the flow rate adjusting valve 26 to adjust the inflow of the raw material liquid pH regulator of a liquid substance from the pH regulator supply pipe 22 to the pH regulator addition point 18a.

The configuration of the extraction system 1 according to the fifth embodiment is similar to that of the extraction system 1 according to the third embodiment, except for the above-described constituent elements.

An extraction method by the extraction system 1 according to the fifth embodiment will then be described.

According to the extraction method of the fifth embodiment, in the process in which, following the extraction treatment at the extractor 6, the raw material liquid separated from the extraction liquid by the separator 14 flows from the separator 14 toward the raw material liquid tank 4 through the raw material liquid return pipe 18, the raw material liquid pH regulator addition apparatus 19 adds the raw material liquid pH regulator of a liquid substance to the raw material liquid at the pH regulator addition point 18a.

The raw material liquid pH sensor 28 successively detects the pH of the raw material liquid at the point on the raw material liquid return pipe 18, the point being upstream of the pH regulator addition point 18a in the direction of flow of the raw material liquid in the raw material liquid return pipe 18, and the flowmeter 48 successively measures the flow rate of the raw material liquid pH regulator flowing through the pH regulator supply pipe 22 toward the pH regulator addition point 18a.

To match the detected pH value of the raw material liquid, the pH value being detected by the raw material liquid pH sensor 28, to the raw material liquid pH optimum value corresponding to the raw material liquid optimum pH, the controller 30 successively calculates a necessary amount of regulator addition to the raw material liquid, which is an amount of the raw material liquid pH regulator of a liquid substance that needs to be added to the raw material liquid in the raw material liquid in the raw material liquid return pipe 18. Specifically, the controller 30 calculates the inflow of the raw material liquid pH regulator of a liquid substance that needs to be sent from the pH regulator supply pipe 22 to the pH regulator addition point 18a of the raw material liquid return pipe 18, as the necessary amount of regulator addition to the raw material liquid. The controller 30 causes the flow rate adjusting valve 26 to change its degree of opening so that the flow rate of the raw material liquid pH regulator measured by the flowmeter 48, that is, the inflow of the raw material liquid pH regulator actually flowing into the pH regulator addition point 18a matches the calculated inflow, i.e., the necessary amount of regulator addition to the raw material liquid, thus causing the flow rate adjusting valve 26 to adjust the inflow of the raw material liquid pH regulator of a liquid substance to the raw material liquid return pipe 18. The controller 30 successively carries out this control of the flow rate adjusting valve 26, based on the detected pH value of the raw material liquid that the controller 30 successively acquires from the raw material liquid pH sensor 28 and on a measurement value of the flow rate of the raw material liquid pH regulator that the controller 30 successively acquires from the flowmeter 48.

Processes other than the above processes of the extraction method according to the fifth embodiment are similar to those of the extraction methods according to the first and third embodiments.

The fifth embodiment offers the same effects as the first embodiment offers, and offers also an effect that the pH of the raw material liquid that has been decreased by the extraction treatment at the extractor 6 can be quickly brought closer to the raw material liquid optimum pH, which effect is the same as the effect the third embodiment offers.

The fifth embodiment further offers an effect of improving the quickness and accuracy of adjusting the pH of the raw material liquid, which has been decreased by the extraction treatment at the extractor 6, to the raw material liquid optimum pH.

Specifically, in the fifth embodiment, the raw material liquid pH sensor 28 detects the pH of the raw material liquid at the point on the raw material liquid return pipe 18, the point being upstream of the pH regulator addition point 18a, that is, detects the pH of the raw material liquid to which, after its pH having been decreased by the extraction treatment at the extractor 6, the raw material liquid pH regulator is not added yet. In the fifth embodiment, therefore, a necessary variation in the amount of addition of the raw material liquid pH regulator, the variation being calculated by the controller 30 based on the detected pH value of the raw material liquid acquired from the raw material liquid pH sensor 28, that is, a necessary variation in the inflow of the pH regulator to the raw material liquid return pipe 18, the variation being necessary for matching the detected pH value to the pH optimum value corresponding to the optimum pH, becomes larger than a necessary variation in the amount of addition of the pH regulator in a case where the variation is calculated based on the detected pH value of the raw material liquid to which the pH regulator has already been added. Based on the calculated necessary variation that is relatively larger, the controller 30 causes the flow rate adjusting valve 26 to adjust the inflow of the pH regulator to the raw material liquid return pipe 18, and this process is more effective in improving the quickness of adjustment of the pH of the raw material liquid, which has been decreased by the extraction treatment at the extractor 6, to the optimum pH.

In the fifth embodiment, to match the detected pH value of the raw material liquid, the pH value being obtained by the raw material liquid pH sensor 28, to the raw material liquid pH optimum value, the controller 30 successively calculates the inflow of the raw material liquid pH regulator of a liquid substance that needs to be sent to the pH regulator addition point 18a of the raw material liquid return pipe 18, and causes the flow rate adjusting valve 26 to change its degree of opening so that an actual inflow of the raw material liquid pH regulator to the pH regulator addition point 18a, the actual inflow being measured by the flowmeter 48, matches the inflow of the raw material liquid pH regulator calculated in the above manner, thus causing the flow rate adjusting valve 26 to adjust the inflow of the raw material liquid pH regulator of a liquid substance to the pH regulator addition point 18a of the raw material liquid return pipe 18. Hence accuracy in adjusting the pH of the raw material liquid in the raw material liquid return pipe 18. i.e., the pH of the raw material liquid that has been decreased by the extraction treatment at the extractor 6, to the raw material liquid optimum pH can be improved.

### Sixth Embodiment

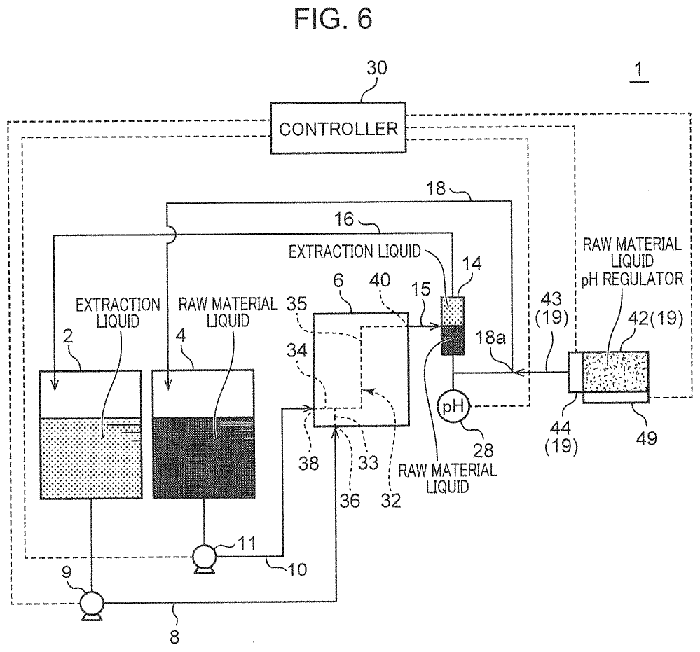

An extraction system 1 according to a sixth embodiment of the present invention will hereinafter be described with reference to FIG. 6.

The extraction system 1 according to the sixth embodiment is different from the extraction system 1 according to the fifth embodiment in the configuration of the raw material liquid pH regulator addition apparatus 19. In the extraction system 1 according to the sixth embodiment, the raw material liquid pH regulator addition apparatus 19 adds the raw material liquid pH regulator of a solid substance to the raw material liquid flowing in the raw material liquid return pipe 18 in order to bring the pH of the raw material liquid, which has been decreased by the extraction treatment at the extractor 6, closer to the raw material liquid optimum pH. The raw material liquid pH regulator addition apparatus 19 according to the sixth embodiment is the same as the raw material liquid pH regulator addition apparatus 19 according to the fourth embodiment.

The extraction system 1 according to the sixth embodiment includes a weighing meter 49 that is attached to the reservoir unit 42 and that measures a total weight of the reservoir unit 42 and the raw material liquid pH regulator of a solid substance held in the reservoir unit 42. The total weight measured by the weighing meter 49 is an index value for an amount of addition of the raw material liquid pH regulator of a solid substance, which is added from the reservoir unit 42 to the raw material liquid return pipe 18, and is an example of a raw material liquid pH regulator index value according to the present invention. The weighing meter 49 is an example of a raw material liquid pH regulator index value detector according to the present invention. The weighing meter 49 successively measures the above total weight. A decrement of the total weight that is determined at every measurement by the weighing meter 49 corresponds to an amount of addition of the raw material liquid pH regulator to the raw material liquid in the raw material liquid return pipe 18. The weighing meter 49 successively transmits data of the total weight measured successively, to the controller 30.

In the extraction system 1 according to the sixth embodiment, the controller 30 causes the addition adjusting unit 44 to adjust the amount of input of the raw material liquid pH regulator of a solid substance, which is inputted from the reservoir unit 42 to the pH regulator addition point 18a, based on the detected pH value of the raw material liquid, the pH value being detected by the raw material liquid pH sensor 28, at a point upstream of the pH regulator addition point 18a of the raw material liquid return pipe 18, and on a measurement value of the total weight measured by the weighing meter 49.

The configuration of the extraction system 1 according to the sixth embodiment is similar to that of the extraction system 1 according to the fifth embodiment, except for the above-described constituent elements.

An extraction method by the extraction system 1 according to the sixth embodiment will then be described.

According to the extraction method of the sixth embodiment, in the process in which, following the extraction treatment at the extractor 6, the raw material liquid separated from the extraction liquid by the separator 14 flows from the separator 14 toward the raw material liquid tank 4 through the raw material liquid return pipe 18, the raw material liquid pH regulator addition apparatus 19 adds the raw material liquid pH regulator of a solid substance to the raw material liquid at the pH regulator addition point 18a.

The raw material liquid pH sensor 28 successively detects the pH of the raw material liquid at the point upstream of the pH regulator addition point 18a of the raw material liquid return pipe 18, and the weighing meter 49 successively measures the total weight of the reservoir unit 42 and the raw material liquid pH regulator of a solid substance held in the reservoir unit 42.

To match the detected pH value of the raw material liquid, the pH value being detected by the raw material liquid pH sensor 28, to the raw material liquid pH optimum value corresponding to the raw material liquid optimum pH, the controller 30 successively calculates a necessary amount of regulator addition to the raw material liquid, which is an amount of the raw material liquid pH regulator of a solid substance that needs to be added to the raw material liquid in the raw material liquid in the raw material liquid return pipe 18. Specifically, the controller 30 calculates the amount of input of the raw material liquid pH regulator of a solid substance that needs to be inputted from the reservoir unit 42 to the pH regulator addition point 18a of the raw material liquid return pipe 18, as the necessary amount of regulator addition to the raw material liquid. The controller 30 then successively calculates a decrement of the total weight from the measurement value of the total weight successively measured by the weighing meter 49. This decrement corresponds to an actual amount of input of the raw material liquid pH regulator of a solid substance, which is inputted from the reservoir unit 42 to the pH regulator addition point 18a. The controller 30 causes the addition adjusting unit 44 to adjust the opening area of the discharge port of the reservoir unit 42 so that the decrement calculated successively matches the amount of input calculated in the above manner as the necessary amount of regulator addition to the raw material liquid, thus causing the addition adjusting unit 44 to adjust the amount of input of the raw material liquid pH regulator of a solid substance, which is inputted from the reservoir unit 42 to the raw material liquid pH regulator 18. The controller 30 successively carries out this control of the addition adjusting unit 44, based on the detected pH value of the raw material liquid that the controller 30 successively acquires from the raw material liquid pH sensor 28 and on a measurement value of the total weight that the controller 30 successively acquires from the weighing meter 49.

Processes other than the above processes of the extraction method according to the sixth embodiment are similar to those of the extraction methods according to the first and fifth embodiments.

The sixth embodiment offers the same effects the first and fourth embodiments offer, and offers also an effect of further improving the quickness of adjustment of the pH of the raw material liquid, which has been decreased by the extraction treatment at the extractor 6, to the optimum pH, which effect is the same as the effect the fifth embodiment offers.

### (Simulation for Examining Effects of Extraction System According to Present Invention)

A simulation of the extraction treatment of extracting metal ions from the raw material liquid, the simulation being carried out to examine effects the extraction system according to the present invention offers, will be described.

This simulation is carried out on the assumption that the metal ions to be extracted are trivalent metal ions M³⁺, and that the raw material liquid is an aqueous solution containing the metal ions M³⁺ at a concentration of 0.5 mol/L. It is also assumed that the pH of the untreated raw material liquid (initial pH) is 1. It is also assumed that a sodium hydroxide aqueous solution containing sodium hydroxide of 0.5 mol/L in concentration is used as the raw material liquid pH regulator.

It is also assumed that the extraction treatment on the raw material liquid causes an extraction reaction expressed by the following reaction formula. In the following reaction formula, HR denotes extractant molecules included in the extraction liquid.

M³⁺+3(HR)→MR₃+3H⁺

This reaction formula expresses a process that extracting 1 mol of metal ion (M3⁺) from the raw material liquid produces 3 mols of hydrogen ions (H⁺). Therefore, as extraction of metal ions from the raw material liquid proceeds, the pH of the raw material liquid drops.

In this simulation, an index log₁₀ D indicating the pH dependency of the extraction equilibrium in the extraction treatment of extracting metal ions from the raw material liquid is set as an equation shown below. It should be noted that D is a value obtained by dividing the concentration of the metal ions M³⁺ in the extraction liquid in a state of extraction equilibrium by the concentration of metal ions M³⁺ in the raw material liquid in a state of extraction equilibrium.

log₁₀ D=3pH−0.5

A case where metal ions M³⁺ are extracted from the raw material liquid, using the extraction system 1 of the first embodiment (see FIG. 1), will be discussed as an example related to the present invention. In this example, the extraction treatment by the extractor 6 is repeated as the extraction liquid and the raw material liquid are circulated in the extraction system 1, and the raw material liquid pH regulator addition apparatus 19 adds the raw material liquid pH regulator of a liquid substance to the raw material liquid in the raw material liquid tank 4 to keep the pH of the raw material liquid in the raw material liquid tank 4, the pH being detected by the raw material liquid pH sensor 28, at 0.5. At a point of time at which the extraction liquid and raw material liquid in circulation reach a state of extraction equilibrium, the extraction liquid having reached the state of extraction equilibrium, the extraction liquid being held in the extraction liquid tank 2 is replaced with an extraction liquid not used for the extraction treatment yet. This cycle of extraction treatment that ends at extraction liquid replacement is defined as one cycle of extraction treatment, and three cycles of extraction treatment are carried out.

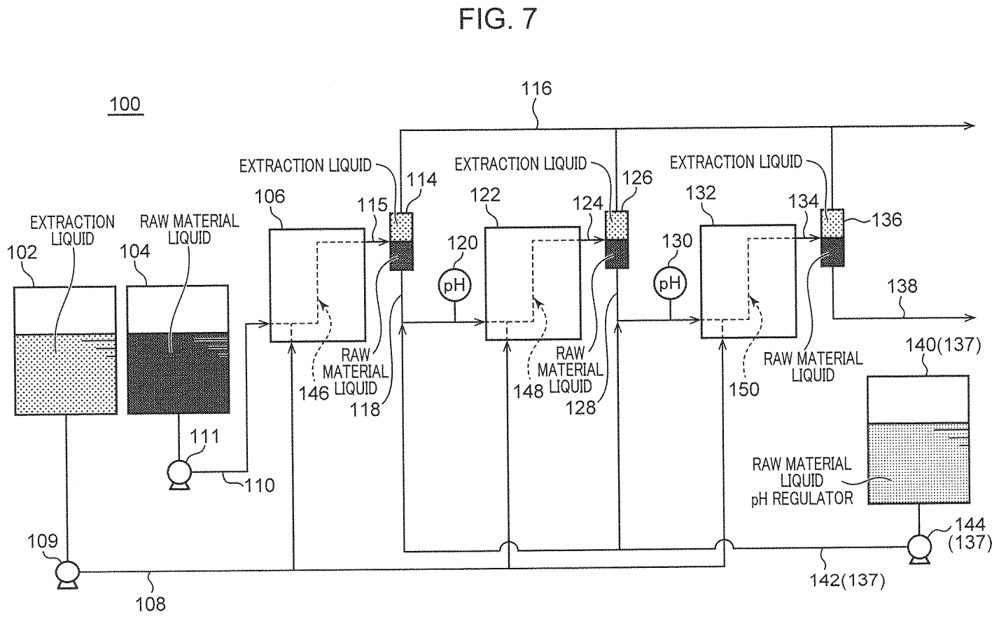

In addition, a comparative example will also be provided, in which metal ions M³⁺ are extracted from the raw material liquid, using an extraction system 100 shown in FIG. 7, that is, an extraction system 100 configured to have three extractors 106, 122, and 132 connected in series, the extractors each carrying out the extraction treatment. The extraction system 100 according to the comparative example includes an extraction liquid tank 102, a raw material liquid tank 104, an extraction liquid supply pipe 108, an extraction liquid feed pump 109, a raw material liquid supply pipe 110, a raw material liquid feed pump 111, a first extractor 106, a first separator 114, a second extractor 122, a second separator 126, a third extractor 132, a third separator 136, a pH regulator addition apparatus 137, a first pH sensor 120, a second pH sensor 130, connection pipes 115, 124, and 134, pipes 118 and 128, an extraction liquid discharge pipe 116, and a raw material liquid discharge pipe 138.

The extraction liquid tank 102 holds an extraction liquid not used for the extraction treatment yet. The extraction liquid tank 102 is connected to respective extraction liquid inlets of the first extractor 106, the second extractor 122, and the third extractor 132, via the extraction liquid supply pipe 108. The extraction liquid held in the extraction liquid tank 102 is sent to respective extraction liquid inlets of the first extractor 106, the second extractor 122, and the third extractor 132, by the extraction liquid feed pump 109 provided on the extraction liquid supply pipe 108.

The raw material liquid tank 104 holds a raw material liquid not treated. The raw material liquid tank 104 is connected to a raw material liquid inlet of the first extractor 106 via the raw material liquid supply pipe 110. The raw material liquid held in the raw material liquid tank 104 is sent to the raw material liquid inlet of the first extractor 106, by the raw material liquid feed pump 111 provided on the raw material liquid supply pipe 110.

Each of the first extractor 106, the second extractor 122, and the third extractor 132 is the same as the extractor 6 of the first embodiment. The first extractor 106 has a plurality of treatment channels 146 therein. The second extractor 122 has a plurality of treatment channels 148 therein. The third extractor 132 has a plurality of treatment channels 150 therein. Each of the first separator 114, the second separator 126, and the third separator 136 is the same as the separator 14 of the first embodiment.

In the treatment channels 146 in the first extractor 106, the extraction liquid sent from the extraction liquid tank 102 and the raw material liquid sent from the raw material liquid tank 104 flow together in a state of being contact with each other, and extraction treatment of extracting metal ions from the raw material liquid is carried out. An outlet of the first extractor 106 is connected to the first separator 114 via the connection pipe 115. A mixture liquid of the extraction liquid and the raw material liquid that have been subjected to the extraction treatment in the treatment channels 146 in the first extractor 106 flows through the connection pipe 115 into the first separator 114.

A part of first separator 114 that holds the separated raw material liquid is connected to a raw material liquid inlet of the second extractor 122, via the pipe 118. The raw material liquid separated by the first separator 114 is sent to the raw material liquid inlet of the second extractor 122 through the pipe 118.

In the treatment channels 148 in the second extractor 122, the extraction liquid sent from the extraction liquid tank 102 and the raw material liquid sent from the first separator 114 flow together in a state of being in contact with each other, and extraction treatment of extracting metal ions from the raw material liquid is carried out. An outlet of the second extractor 122 is connected to the second separator 126 via the connection pipe 124. A mixture liquid of the extraction liquid and the raw material liquid that have been subjected to the extraction treatment in the treatment channels 148 in the second extractor 122 flows through the connection pipe 124 into the second separator 126.

A part of second separator 126 that holds the separated raw material liquid is connected to a raw material liquid inlet of the third extractor 132 via the pipe 128. The raw material liquid separated by the second separator 126 is sent to the raw material liquid inlet of the third extractor 132 through the pipe 128.

In the treatment channels 150 in the third extractor 132, the extraction liquid sent from the extraction liquid tank 102 and the raw material liquid sent from the second separator 126 flow together in a state of being in contact with each other, and extraction treatment of extracting metal ions from the raw material liquid is carried out. An outlet of the third extractor 132 is connected to the third separator 136 via the connection pipe 134. A mixture liquid of the extraction liquid and the raw material liquid that have been subjected to the extraction treatment in the treatment channels 150 in the third extractor 132 flows through the connection pipe 134 into the third separator 136.

A part of third separator 136 that holds the separated raw material liquid is connected to the raw material liquid discharge pipe 138. The raw material liquid separated by the third separator 136 is discharged through the raw material liquid discharge pipe 138.

Respective parts of first, second, and third separators 114,126, and 136 that hold the separated extraction liquid are connected to the extraction liquid discharge pipe 116. The extraction liquid separated by each of the first, second, and third separators 114,126, and 136 is discharged through the extraction liquid discharge pipe 116.

The first pH sensor 120 is connected to the pipe 118, and detects pH of the raw material liquid flowing through the pipe 118. The second pH sensor 130 detects pH of the raw material liquid flowing through the pipe 128.

The pH regulator addition apparatus 137 adds the raw material liquid pH regulator to the raw material liquid having been subjected to the extraction treatment at the first extractor 106, separated by the first separator 114, and then sent to the second extractor 122 through the pipe 118, and to the raw material liquid having been subjected to the extraction treatment at the second extractor 122, separated by the second separator 126, and then sent to the third extractor 132 through the pipe 128. The pH regulator addition apparatus 137 has a reservoir unit 140, a pH regulator supply pipe 142, and a pH regulator supply pump 144. The pH regulator supply pipe 142 connects the pipe 118 between the first separator 114 and the second extractor 122 to the reservoir unit 140. The pH regulator supply pipe 142 connects the pipe 128 between the second separator 126 and the third extractor 132 to the pH regulator reservoir unit 140. The pH regulator supply pump 144 is provided on the pH regulator supply pipe 142. The pH regulator supply pump 144 supplies the raw material liquid pH regulator from the reservoir unit 140 to each of the pipes 118 and 128 through the pH regulator supply pipe 142, thereby adding the raw material liquid pH regulator to the raw material liquid flowing through the pipes 118 and 128.

In the comparative example using the extraction system 100 configured in the above manner, the raw material liquid pH regulator is added to the raw material liquid having been subjected to the extraction treatment at the first extractor 106, separated by the first separator 114, and then sent to the second extractor 122, and to the raw material liquid having been subjected to the extraction treatment at the second extractor 122, separated by the second separator 126, and then sent to the third extractor 132. This process adjusts the pH values of both flows of the raw material liquid, i.e., pH values detected respectively by the first pH sensor 120 and the second pH sensor 130, to 0.5.

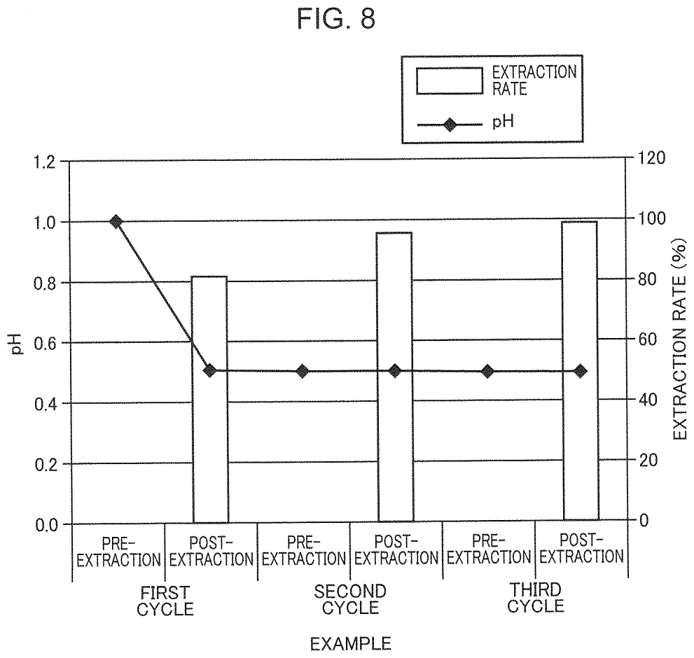

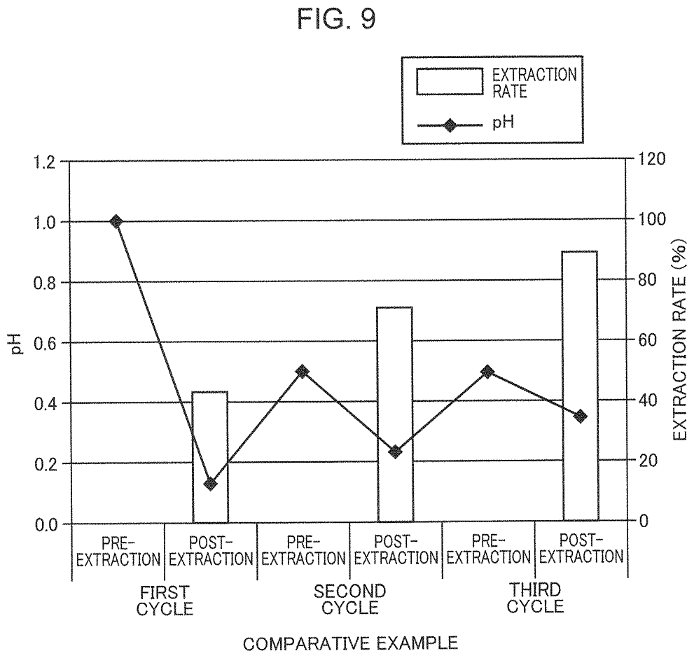

FIG. 8 shows a result of a simulation in which the extraction treatment is carried out in the above example, while FIG. 9 shows a result of a simulation in which the extraction treatment is carried out in the comparative example.

These simulation results demonstrate that a metal ion extraction rate of the raw material liquid subjected to three cycles of extraction treatment stands at 89.4% in the comparative example, whereas the same stands at 99.3% in the example. This leads to a finding that the example gives an extraction rate higher than an extraction rate given by the comparative example. This is because that a time during which the pH of the raw material liquid is kept at 0.5, which is the optimum pH for the extraction treatment, is longer in the example than in the comparative example.

The simulations also reveal that when the volume of the raw material liquid is defined as 100, the total amount of the raw material liquid pH regulator added to the raw material liquid is 104 in the comparative example, whereas the total amount of the raw material liquid pH regulator added to the raw material liquid is 156 in the example. This leads to a finding that the amount of addition of the raw material liquid pH regulator of a liquid substance to the raw material liquid is larger in the example than in the comparative example. An increase in the amount of addition of the raw material liquid pH regulator of a liquid substance raises a concern that the amount of the raw material liquid discarded as waste liquid may increase after completion of extraction of metal ions. To deal with this problem, for example, the raw material liquid pH regulator of a solid substance is added in place of the raw material liquid pH regulator of a liquid substance, to the raw material liquid. This allows a reduction in the amount of addition (volume) of the raw material liquid pH regulator, and therefore suppresses an increase in the amount of the raw material liquid discarded as waste liquid after completion of extraction of metal ions.

### (Modifications)

The extraction system according to the present invention is not necessarily limited to the above embodiments. To the extraction system according to the present invention, for example, the following techniques may be applied.

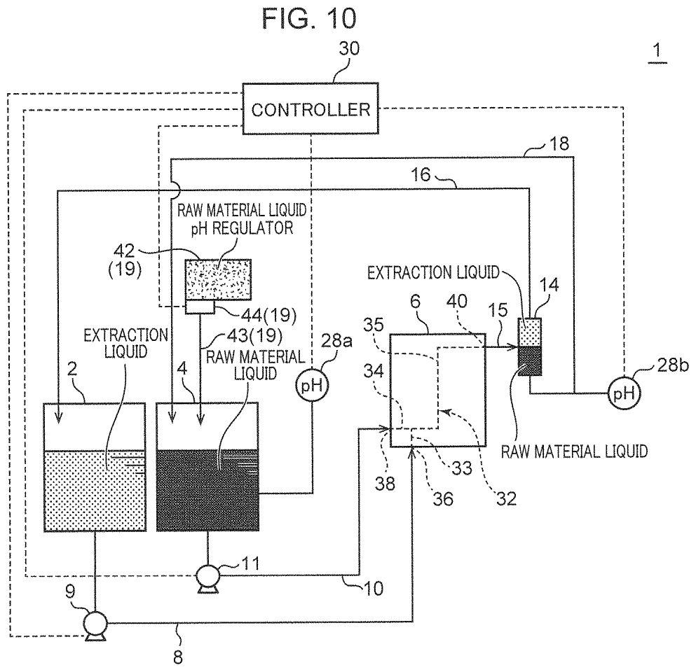

(1) A technique may be applied, according to which the pH value of the raw material liquid having the raw material liquid pH regulator added thereto but not subjected to the extraction treatment by the extractor yet, that is, the pH value of the raw material liquid not led into the treatment channels in the extractor yet and the pH value of the raw material liquid having been subjected to the extraction treatment by the extractor but not having the raw material liquid pH regulator added thereto yet are both detected, and whether extraction of metal ions from the raw material liquid has been completed is determined based on these detected pH values. FIG. 10 shows an extraction system 1 according to a first modification to which such a technique is applied.

The basic configuration of the extraction system 1 according to the first modification is similar to that of the extraction system 1 according to the second embodiment. The extraction system 1 according to the first modification, however, includes a pre-extraction pH sensor 28a and a post-extraction pH sensor 28b.

The pre-extraction pH sensor 28a detects pH of the raw material liquid having the raw material liquid pH regulator added thereto by the raw material liquid pH regulator addition apparatus 19 but not subjected to the extraction treatment by the extractor 6 yet. Specifically, the pre-extraction pH sensor 28a is connected to the raw material liquid tank 4, and detects the pH of the raw material liquid in the raw material liquid tank 4, the raw material liquid having the raw material liquid pH regulator added thereto by the raw material liquid pH regulator addition apparatus 19. The pre-extraction pH sensor 28a successively detects the pH of the raw material liquid in the raw material liquid tank 4, and successively transmits data of the detected pH value to the controller 30.

The post-extraction pH sensor 28b detects the pH of the raw material liquid having been subjected to the extraction treatment by the extractor 6 but not having the raw material liquid pH regulator added thereto by the raw material liquid pH regulator addition apparatus 19 yet. Specifically, the post-extraction pH sensor 28b is connected to the raw material liquid return pipe 18, and detects the pH of the raw material liquid having been subjected to the extraction treatment by the extractor 6, separated from the extraction liquid by the separator 14, and then come out of the separator 14 to flow in the raw material liquid return pipe 18. The post-extraction pH sensor 28b successively detects the pH of the raw material liquid in the raw material liquid return pipe 18, and successively transmits data of the detected pH value to the controller 30.

When a pre-extraction/post-extraction pH difference, which is a pH difference obtained by subtracting the pH of the raw material liquid detected by the post-extraction pH sensor 28b from the pH of the raw material liquid detected by the pre-extraction pH sensor 28a, is larger than a raw material liquid pH difference specified value, the controller 30 causes the raw material liquid feed pump 11 and the extraction liquid feed pump 9 to keep operating. When the pre-extraction/post-extraction pH difference is equal to or smaller than the raw material liquid pH difference specified value, on the other hand, the controller 30 stops the raw material liquid feed pump 11 and the extraction liquid feed pump 9 from operating. The raw material liquid pH difference specified value is a preset value serving as a reference for determining whether extraction of metal ions from the raw material liquid has been completed, and is a value close to 0.

Until extraction of metal ions from the raw material liquid is completed, the pH of the raw material liquid having been subjected to the extraction treatment by the extractor 6 drops from the pH of the raw material liquid not subjected to the extraction treatment by the extractor 6 yet. However, when extraction of metal ions from the raw material liquid is completed, the pH of the raw material liquid having been subjected to the extraction treatment by the extractor 6 hardly changes from the pH of the raw material liquid not subjected to the extraction treatment by the extractor 6 yet. For this reason, in the first modification, the raw material liquid pH difference specified value is set close to 0, and the controller 30 determines whether extraction of metal ions from the raw material liquid has been completed, based on a relationship in size between the pre-extraction/post-extraction pH difference and the raw material liquid pH difference specified value. When the pre-extraction/post-extraction pH difference is larger than the raw material liquid pH difference specified value, the controller 30 determines that extraction of metal ions from the raw material liquid has not been completed yet, and causes the raw material liquid feed pump 11 and the extraction liquid feed pump 9 to keep operating, thus causing the extraction system 1 to continue the extraction treatment. On the other hand, when the pre-extraction/post-extraction pH difference is equal to or smaller than the raw material liquid pH difference specified value, the controller 30 determines that extraction of metal ions from the raw material liquid has been completed, and stops the raw material liquid feed pump 11 and the extraction liquid feed pump 9 from operating, thus causing the extraction system 1 to end the extraction treatment.

In the first modification, the pre-extraction pH sensor 28a serves also as a raw material liquid pH sensor that detects the pH of the raw material liquid in the raw material liquid tank 4, the pH being a reference value based on which the controller 30 causes the addition adjusting unit 44 to adjust the amount of input of the raw material liquid pH regulator of a solid substance, which is inputted from the reservoir unit 42 to the raw material liquid tank 4. In the extraction system 1 according to the first modification, the pH sensor that detects the pH of the raw material liquid, the pH serving as the reference value based on which control by the addition adjusting unit 44 is performed, and the pre-extraction pH sensor may be provided respectively as separate sensors.

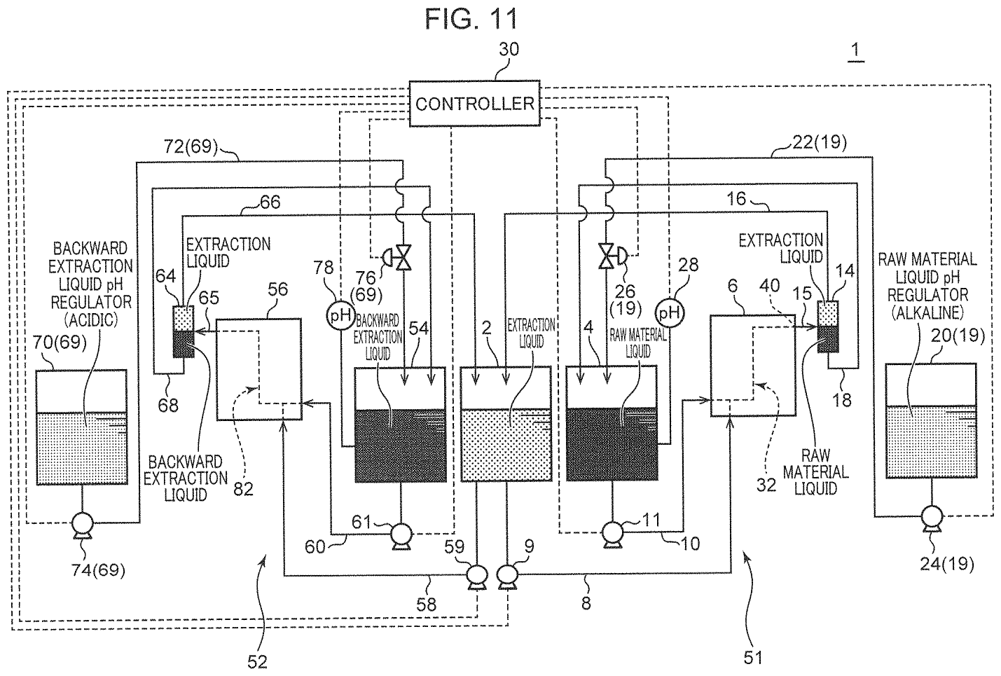

(2) The extraction system according to the present invention may include a backward extraction apparatus that leads a post-extraction extraction liquid, which is the extraction liquid containing metal ions extracted from the raw material liquid by the extraction treatment, out of the extraction liquid tank, that carries out a backward extraction treatment of bringing the post-extraction extraction liquid into contact with a backward extraction liquid to extract the metal ions from the post-extraction extraction liquid and causing the metal ions to migrate to the backward extraction liquid, and that returns a post-backward-extraction extraction liquid, which is the post-extraction extraction liquid having been subjected to the backward extraction treatment, to the extraction liquid tank. FIG. 11 depicts an extraction system 1 according to a second modification to which a technique mentioned in (2) is applied.

The extraction system 1 according to the second modification includes an extraction apparatus 51 that carries out the extraction treatment while circulating the extraction liquid and the raw material liquid, and a backward extraction apparatus 52 that carries out the backward extraction treatment on the post-extraction extraction liquid having been subjected to the extraction treatment by the extraction apparatus 51.

The configuration of the extraction apparatus 51 is similar to the configuration of the extraction system 1 according to the first embodiment. The extraction apparatus 51 includes the extraction liquid tank 2, the raw material liquid tank 4, the extractor 6, the extraction liquid supply pipe 8, the extraction liquid feed pump 9, the raw material liquid supply pipe 10, the raw material liquid feed pump 11, the separator 14, the connection pipe 15, the extraction liquid return pipe 16, the raw material liquid return pipe 18, the raw material liquid pH regulator addition apparatus 19, the raw material liquid pH sensor 28, and the controller 30.

The backward extraction apparatus 52 is connected to the extraction liquid tank 2 of the extraction apparatus 51. The backward extraction apparatus 52 includes a backward extraction liquid tank 54, a backward extractor 56, a post-extraction extraction liquid lead-out pipe 58, a post-extraction extraction liquid feed pump 59, a backward extraction liquid supply pipe 60, a backward extraction liquid feed pump 61, a post-backward-extraction separator 64, a post-backward-extraction extraction liquid return pipe 66, a backward extraction liquid return pipe 68, a backward extraction liquid pH regulator addition apparatus 69, and a backward extraction liquid pH sensor 78.

The backward extraction liquid tank 54 holds the backward extraction liquid for backward-extracting metal ions from the post-extraction extraction liquid. The backward extraction liquid is incompatible with the post-extraction extraction liquid, and is provided as, for example, water. This backward extraction liquid has a specific gravity larger than that of the post-extraction extraction liquid. The backward extraction liquid tank 54 holds an unused backward extraction liquid, which is a backward extraction liquid not used for the backward extraction treatment yet, before the start of the backward extraction treatment, and after the start of the backward extraction treatment, receives a post-backward-extraction backward extraction liquid led to the backward extraction liquid tank 54, and holds the post-backward-extraction backward extraction liquid. The post-backward-extraction backward extraction liquid is the backward extraction liquid having been subjected to the backward extraction treatment at the backward extractor 56 and then separated from the post-backward-extraction extraction liquid by the post-backward-extraction separator 64.

The backward extractor 56 is connected to the extraction liquid tank 2 via the post-extraction extraction liquid lead-out pipe 58 (hereinafter, simply referred to as a lead-out pipe 58) so that the post-extraction extraction liquid is led from the extraction liquid tank 2 to the backward extractor 56. The backward extractor 56 is connected to the backward extraction liquid tank 54 via the backward extraction liquid supply pipe 60 so that the backward extraction liquid is led from the backward extraction liquid tank 54 to the backward extractor 56. The backward extractor 56 carries out the backward extraction treatment of bringing the post-extraction extraction liquid led in from the extraction liquid tank 2 into contact with the backward extraction liquid led in from the backward extraction liquid tank 54, thereby extracting metal ions from the post-extraction extraction liquid and causing the extracted metal ions to migrate to the backward extraction liquid. This backward extractor 56 is configured in the same manner as the extractor 6. The backward extractor 56 has a number of treatment channels 82 therein.

To each treatment channel 82, the post-extraction extraction liquid is sent from the extraction liquid tank 2 through the lead-out pipe 58 and the backward extraction liquid is sent from the backward extraction liquid tank 54 through the backward extraction liquid supply pipe 60. Each treatment channel 82 let the post-extraction extraction liquid and the backward extraction liquid flow therethrough so that the post-extraction extraction liquid and backward extraction liquid, which are led to the treatment channel 82, come in contact with each other to cause metal ions to be extracted from the post-extraction extraction liquid and migrate to the backward extraction liquid. The configuration of the treatment channel 82 is similar to the configuration of the treatment channel 32 in the extractor 6.

The post-extraction extraction liquid feed pump 59 is provided on the lead-out pipe 58. The post-extraction extraction liquid feed pump 59 pumps the post-extraction extraction liquid out of the extraction liquid tank 2 to lead the post-extraction extraction liquid to the lead-out pipe 58, and sends the post-extraction extraction liquid to the backward extractor 56 through the lead-out pipe 58.

The backward extraction liquid feed pump 61 is provided on the backward extraction liquid supply pipe 60. The backward extraction liquid feed pump 61 sends the backward extraction liquid held in the backward extraction liquid tank 54, from the backward extraction liquid tank 54 to the backward extractor 56 through the backward extraction liquid supply pipe 60.

The post-backward-extraction separator 64 is a container that separates a post-backward-extraction mixture liquid, which is a mixture liquid of the post-backward-extraction extraction liquid and the post-backward-extraction backward extraction liquid that have been subjected to the backward extraction treatment in each treatment channel 82 of the backward extractor 56, into the post-backward-extraction extraction liquid and the post-backward-extraction backward extraction liquid. The post-backward-extraction separator 64 is similar to the separator 14 of the extraction apparatus 51. The post-backward-extraction separator 64 is connected to an outlet of the backward extractor 56 via the connection pipe 65. The post-backward-extraction separator 64 receives the post-backward-extraction mixture liquid discharged from the outlet of the backward extractor 56, through the connection pipe 65. The post-backward-extraction separator 64 holds the received post-backward-extraction mixture liquid temporarily, and phase-separates the post-backward-extraction mixture liquid into the post-backward-extraction extraction liquid (light liquid) and the post-backward-extraction backward extraction liquid (heavy liquid) vertically by a difference in specific gravity between both liquids. The separated post-backward-extraction backward extraction liquid (heavy liquid) precipitates on the bottom of the post-backward-extraction separator 64, and the separated post-backward-extraction extraction liquid (light liquid) settles above the precipitated post-backward-extraction backward extraction liquid. For simpler description, the post-backward-extraction separator 64 will hereinafter be referred to as the separator 64.

The post-backward-extraction extraction liquid return pipe 66 connects an area of separator 64 that holds the separated post-backward-extraction extraction liquid to the extraction liquid tank 2 so as to lead the post-backward-extraction extraction liquid separated by the separator 64, from the separator 64 to the extraction liquid tank 2. The post-backward-extraction extraction liquid return pipe 66 is an example of a post-backward-extraction extraction liquid return path according to the present invention.

The backward extraction liquid return pipe 68 connects an area of separator 64 that holds the separated post-backward-extraction backward extraction liquid to the backward extraction liquid tank 54 so as to lead the post-backward-extraction backward extraction liquid separated by the separator 64, from the separator 64 to the backward extraction liquid tank 54. The backward extraction liquid return pipe 68 is an example of a backward extraction liquid return path according to the present invention.

The backward extraction liquid pH regulator addition apparatus 69 is connected to the backward extraction liquid tank 54. The backward extraction liquid pH regulator addition apparatus 69 adds a backward extraction liquid pH regulator to the backward extraction liquid in the backward extraction liquid tank 54, the backward extraction liquid pH regulator decreasing pH of the backward extraction liquid (post-backward-extraction backward extraction liquid) that has been increased by the backward extraction treatment at the backward extractor 56. In the second modification, the backward extraction liquid pH regulator is a liquid substance, which is an acidic aqueous solution that decreases the pH of the post-backward-extraction backward extraction liquid, such as an aqueous solution of hydrochloric acid, an aqueous solution of nitric acid, or an aqueous solution of sulfuric acid. The backward extraction liquid pH regulator addition apparatus 69 has a backward extraction liquid pH regulator reservoir unit 70, a backward extraction liquid pH regulator supply pipe 72, a backward extraction liquid pH regulator supply pump 74, and a backward extraction liquid pH regulator flow rate adjusting valve 76.

The backward extraction liquid pH regulator reservoir unit 70 is a tank that holds the backward extraction liquid pH regulator of a liquid substance. For simpler description, the backward extraction liquid pH regulator reservoir unit 70 will hereinafter be referred to as a reservoir unit 70.

The backward extraction liquid pH regulator supply pipe 72 connects the reservoir unit 70 to the backward extraction liquid tank 54 so as to lead the backward extraction liquid pH regulator held in the reservoir unit 70 to the backward extraction liquid tank 54. For simpler description, the backward extraction liquid pH regulator supply pipe 72 will hereinafter be referred to as the pH regulator supply pipe 72.

The backward extraction liquid pH regulator supply pump 74 is provided on the backward extraction liquid pH regulator supply pipe 72. For simpler description, the backward extraction liquid pH regulator supply pump 74 will hereinafter be referred to as the pH regulator supply pump 74. The pH regulator supply pump 74 sends the backward extraction liquid pH regulator held in the reservoir unit 70, from the reservoir unit 70 to the backward extraction liquid tank 54 through the pH regulator supply pipe 72.

The backward extraction liquid pH regulator flow rate adjusting valve 76 is provided at a point on the pH regulator supply pipe 72, the point being downstream of the pH regulator supply pump 74 in the direction of flow of the backward extraction liquid pH regulator in the pH regulator supply pipe 72. For simpler description, the backward extraction liquid pH regulator flow rate adjusting valve 76 will hereinafter be referred to as the flow rate adjusting valve 76. The flow rate adjusting valve 76 is an example of a backward extraction liquid pH regulator addition adjusting unit according to the present invention, and is capable of adjusting an amount of addition of the backward extraction liquid pH regulator, which is added from the reservoir unit 70 to the backward extraction liquid in the backward extraction liquid tank 54, to any given amount of addition. Specifically, the flow rate adjusting valve 76 is capable of changing its degree of opening. The flow rate adjusting valve 76 adjusts a flow rate of the backward extraction liquid pH regulator flowing from the reservoir unit 70 through the pH regulator supply pipe 72 to the backward extraction liquid tank 54, to a flow rate corresponding to a degree of opening of the flow rate adjusting valve 76, thereby adjusting an amount of addition of the backward extraction liquid pH regulator to the backward extraction liquid in the backward extraction liquid tank 54, to any given amount of addition.

The backward extraction liquid pH sensor 78 is connected to the backward extraction liquid tank 54. The backward extraction liquid pH sensor 78 successively detects the pH of the backward extraction liquid in the backward extraction liquid tank 54, and successively transmits data of the detected pH value to the controller 30.

The controller 30 acquires data of the detected pH value successively transmitted from the backward extraction liquid pH sensor 78, and based on the acquired detected pH value, causes the flow rate adjusting valve 76 to adjust the flow rate of the backward extraction liquid pH regulator flowing from the reservoir unit 70 to the backward extraction liquid tank 54 through the pH regulator supply pipe 72. Specifically, the controller 30 causes the flow rate adjusting valve 76 to adjust its degree of opening to adjust the flow rate of the backward extraction liquid pH regulator so that the acquired detected pH value approaches a preset backward extraction liquid pH optimum value. The backward extraction liquid pH optimum value is the value corresponding to the pH of the backward extraction liquid that is optimum for the backward extraction treatment by the backward extractor 56 of backward-extracting metal ions from the post-extraction extraction liquid. The pH of the backward extraction liquid that is optimum for the backward extraction treatment is the pH at which the rate of extraction of metal ions from the post-extraction extraction liquid is high. The controller 30 is an example of a backward extraction apparatus controller according to the present invention. This means that, according to the second modification, the controller 30 serves both as the controller and the backward extraction apparatus controller according to the present invention. It should be noted that the controllers corresponding respectively to the controller and the backward extraction apparatus controller according to the present invention may be provided as separate controllers.

In the extraction system 1 according to the second modification, the extraction apparatus 51 causes the extractor 6 to repeatedly carry out the extraction treatment of extracting metal ions from the raw material liquid in the treatment channel 32 while circulating the extraction liquid and the raw material liquid, similar to the extraction system 1 according to the first embodiment. As the extraction apparatus 51 proceeds with the extraction treatment while circulating the extraction liquid and the raw material liquid, the backward extraction apparatus 52 causes the backward extractor 56 to repeatedly carry out the backward extraction treatment of backward-extracting metal ions from the post-extraction extraction liquid in the treatment channel 82 while circulating the post-extraction extraction liquid and the backward extraction liquid.

Specifically, the controller 30 actuates the backward extraction liquid feed pump 61 to cause it to send the unused backward extraction liquid from the backward extraction liquid tank 54 to the backward extractor 56 through the backward extraction liquid supply pipe 60, and actuates also the post-extraction extraction liquid feed pump 59 to cause it to send the post-extraction extraction liquid from the extraction liquid tank 2 to the backward extractor 56 through the lead-out pipe 58.

The backward extraction liquid and the post-extraction extraction liquid, which am sent to the backward extractor 56, join in each treatment channel 82 in the backward extractor 56 and flow therein in a state of being in contact with each other. In this condition, the backward extraction treatment is carried out, that is, metal ions are extracted from the post-extraction extraction liquid and migrate to the backward extraction liquid. Subsequently, a mixture liquid of the post-backward-extraction backward extraction liquid, which is the backward extraction liquid having been subjected to the backward extraction treatment, and the post-backward-extraction extraction liquid, which is the post-extraction extraction liquid having been subjected to the backward extraction treatment, is discharged from each treatment channel 82 and flows through the connection pipe 65 into the separator 64.

The mixture liquid led into the separator 64 stays therein, and is phase-separated vertically into the post-backward-extraction extraction liquid (light liquid) and the post-backward-extraction backward extraction liquid (heavy liquid) by a difference in specific gravity between both liquids. The post-backward-extraction extraction liquid separated in the separator 64 comes out of the separator 64 and flows through the post-backward-extraction extraction liquid return pipe 66 to the extraction liquid tank 2 and is held in the extraction liquid tank 2. Meanwhile, the post-backward-extraction backward extraction liquid separated in the separator 64 comes out of the separator 64 and flows through the backward extraction liquid return pipe 68 to the backward extraction liquid tank 54 and is held in the backward extraction liquid tank 54. In the above-described manner, the backward extraction liquid and the post-extraction extraction liquid circulate such that the backward extraction liquid flowing out of the backward extraction liquid tank 54 travels through the treatment channel 82 of the backward extractor 56 and the separator 64 and returns to the backward extraction liquid tank 54, and that the post-extraction extraction liquid flowing out of the extraction liquid tank 2 travels through the treatment channel 82 of the backward extractor 56 and the separator 64 and returns to the extraction liquid tank 2. As this circulation process goes on, the backward extraction treatment is repeatedly carried out in the treatment channel 82 in the backward extractor 56. The post-extraction extraction liquid has an increased metal ion concentration by its performing extraction of metal ions from the raw material liquid at the extractor 6 of the extraction apparatus 51, and therefore has lower extraction capability. However, the backward extraction treatment by the backward extraction apparatus 52 decreases the metal ion concentration of this post-extraction extraction liquid, which is now the post-backward-extraction extraction liquid, thus allowing the post-backward-extraction extraction liquid to restore its extraction capability. The post-backward-extraction extraction liquid with restored extraction capability is used for the extraction treatment in the extraction apparatus 51.

Meanwhile, as a result of the backward extraction treatment, the backward extraction liquid has its metal ion concentration increased, and consequently its pH rises to deviate from the optimum pH for the backward extraction treatment. This results in a decline in the extraction rate in the backward extraction treatment. To deal with this problem, the pH regulator addition apparatus 69 adds the backward extraction liquid pH regulator to the post-backward-extraction backward extraction liquid in the backward extraction liquid tank 54, thereby decreasing the pH of the post-backward-extraction backward extraction liquid, the pH having been increased by the backward extraction treatment, to bring the pH closer to the optimum pH for the backward extraction treatment.

Specifically, the controller 30 actuates the pH regulator supply pump 74 to cause it to send the backward extraction liquid pH regulator from the reservoir unit 70 to the backward extraction liquid tank 54 through the pH regulator supply pipe 72. The backward extraction liquid pH regulator sent to the backward extraction liquid tank 54 is added to the backward extraction liquid in the backward extraction liquid tank 54. As a result, the pH of the post-backward-extraction backward extraction liquid drops to approach the optimum pH for the backward extraction treatment.

Based on the detected pH value of the backward extraction liquid in the backward extraction liquid tank 54, the pH value being detected by the backward extraction liquid pH sensor 78, the controller 30 then causes the flow rate adjusting valve 76 to adjust the inflow of the backward extraction liquid pH regulator from the pH regulator supply pipe 72 to the backward extraction liquid tank 54, thereby adjusting the amount of addition of the backward extraction liquid pH regulator to the backward extraction liquid in the backward extraction liquid tank 54.

Specifically, the backward extraction liquid pH sensor 78 successively detects the pH of the backward extraction liquid in the backward extraction liquid tank 54, and successively transmits data of the detected pH value to the controller 30. The controller 30 acquires data of the detected pH value successively transmitted from the backward extraction liquid pH sensor 78. The controller 30 calculates a necessary variation in the amount of addition of the backward extraction liquid pH regulator to the backward extraction liquid in the backward extraction liquid tank 54, the variation being necessary for matching the acquired detected pH value to the backward extraction liquid pH optimum value corresponding to the optimum pH for of the backward extraction treatment, that is, specifically, calculates a necessary variation in the inflow of the backward extraction liquid pH regulator from the pH regulator supply pipe 72 to the backward extraction liquid tank 54. More specifically, the controller 30 first calculates a difference between the backward extraction liquid pH optimum value and the acquired detected pH value. The controller 30 stores therein a correlation between a variation in the inflow of the backward extraction liquid pH regulator to the backward extraction liquid tank 54 and a variation in the pH of the backward extraction liquid in the backward extraction liquid tank 54, the correlation being derived in advance, The controller 30 defines the calculated difference between the backward extraction liquid pH optimum value and the detected pH value, as the variation in the pH, and based on the correlation, calculates a variation in the inflow of the backward extraction liquid pH regulator to the backward extraction liquid tank 54, the variation corresponding to the difference defined as the variation in the pH. The controller 30 then causes the flow rate adjusting valve 76 to change its degree of opening in such a way as to achieve the calculated variation in the inflow of the backward extraction liquid pH regulator to the backward extraction liquid tank 54, thus causing the flow rate adjusting valve 76 to adjust the inflow of the backward extraction liquid pH regulator to the backward extraction liquid tank 54. The controller 30 successively carries out this control of the flow rate adjusting valve 76, based on the detected pH value that the controller 30 successively acquires from the backward extraction liquid pH sensor 78.

In the extraction system 1 according to the second modification, the post-extraction extraction liquid, whose metal ion content increases while extraction capability decreases as a result of repetition of the extraction treatment by the extractor 6, is subjected to the backward extraction treatment by the backward extraction apparatus 52, which reduces the metal ion content of the post-extraction extraction liquid and restores the extraction capability of the same. This post-extraction extraction liquid with the restored extraction capability, i.e., the post-backward-extraction extraction liquid can be sent from the backward extraction apparatus 52 back to the extraction liquid tank 2. According to the extraction system 1 of the second modification, therefore, even when the extraction capability of the extraction liquid decreases as a result of repetition of the extraction treatment at the extractor 6, the extraction capability of the extraction liquid is restored to allow the extractor 6 to carry out the extraction treatment at a fine extraction rate. In addition, according to the extraction system 1 of the second modification, replacing the post-extraction extraction liquid with decreased extraction capability in the extraction liquid tank 2 is unnecessary. This saves an operator trouble, and reduces time required for replacement work.

According to the extraction system 1 of the second modification, in the backward extraction apparatus 52, the backward extractor 56 solely carries out, in repetition, the backward extraction treatment of extracting metal ions from the post-extraction extraction liquid as the post-extraction extraction liquid and the backward extraction liquid are circulated, and in every cycle of the circulation of both liquids, the backward extraction liquid pH regulator is added to the backward extraction liquid to bring the pH of the backward extraction liquid closer to the optimum pH for the backward extraction treatment. Thus, compared with a case where the backward extraction apparatus 52 includes a plurality of backward extractors that carry out the backward extraction treatment, a time for the backward extraction treatment in which the pH of the backward extraction liquid is close to the optimum pH for the backward extraction treatment can be increased while an increase in the size and configuration complexity of the extraction system 1 is suppressed. In addition, properly changing the number of times of circulating the post-extraction extraction liquid and the backward extraction liquid allows flexibly dealing with changes in the metal ion content of the post-extraction extraction liquid held in the extraction liquid tank 2 and properly setting a time for the backward extraction treatment by which backward extraction of metal ions from the post-extraction extraction liquid is completed.

In addition, according to the extraction system 1 of the second modification, the controller 30 adjusts the degree of opening of the flow rate adjusting valve 76 to adjust the amount of addition of the backward extraction liquid pH regulator, which is added from the reservoir unit 70 to the backward extraction liquid in the backward extraction liquid tank 54, so that the detected pH value of the backward extraction liquid in the backward extraction liquid tank 54, the pH value being detected by the backward extraction liquid pH sensor 78, approaches the backward extraction liquid pH optimum value corresponding to the optimum pH for the backward extraction treatment set in advance. Thus, the pH of the backward extraction liquid in the backward extraction liquid tank 54 can be adjusted to be closer to the optimum pH for the backward extraction treatment, and as a result, the pH of the backward extraction liquid supplied to the backward extractor 56 can be brought closer to the optimum pH for the backward extraction treatment by the backward extractor 56.

In the second modification, the backward extraction treatment at the backward extraction apparatus 52 is carried out simultaneously with the extraction treatment at the extraction apparatus 51. However, the extraction treatment at the extraction apparatus 51 and the backward extraction treatment at the backward extraction apparatus 52 may be carried out alternately in such a way that, for example, after the backward extraction treatment at the backward extraction apparatus 52 is carried out for a given time, the extraction treatment at the extraction apparatus 51 is carried out for a given time, and thereafter the extraction treatment at the extraction apparatus 51 is resumed.

In this case, for example, the following configuration may be adopted, in which the extraction apparatus 51 includes the same sensors as the pre-extraction pH sensor 28a and the post-extraction pH sensor 28b according to the first modification, the controller 30 determines whether extraction of metal ions from the raw material liquid by the extraction treatment at the extraction apparatus 51 is completed, based on a difference between a detected pH value from the pre-extraction pH sensor 28a and a detected pH value from the post-extraction pH sensor 28b, and when the controller 30 determines that the extraction is completed, the controller 30 stops the extraction liquid feed pump 9, the raw material liquid feed pump 11, and the pH regulator supply pump 24 from operating while actuating the post-extraction extraction liquid feed pump 59, the backward extraction liquid feed pump 61, and the pH regulator supply pump 74 to cause the backward extraction apparatus 52 to start the backward extraction treatment.

Furthermore, in this case, the backward extraction apparatus 52 may include a pre-backward-extraction pH sensor that detects the pH of the backward extraction liquid having the backward extraction liquid pH regulator added thereto by the pH regulator addition apparatus 69 but not subjected to the backward extraction treatment by the backward extractor 56 yet, and a post-backward-extraction pH sensor that detects the pH of the backward extraction liquid having been subjected to the backward extraction treatment by the backward extractor 56 but not having the backward extraction liquid pH regulator added thereto by the pH regulator addition apparatus 69 yet, and the controller 30 may determine whether backward extraction of metal ions from the post-extraction extraction liquid by the backward extraction treatment at the backward extraction apparatus 52 is completed, based on a difference between a detected pH value detected by the pre-backward-extraction pH sensor and a detected pH value detected by the post-backward-extraction pH sensor, and when determining that the backward extraction is completed, the controller 30 may stop the post-extraction extraction liquid feed pump 59, the backward extraction liquid feed pump 61, and the pH regulator supply pump 74 from operating while causing the extraction liquid feed pump 9, the raw material liquid feed pump 11, and the pH regulator supply pump 24 to start operating again to resume the extraction treatment in the extraction apparatus 51.

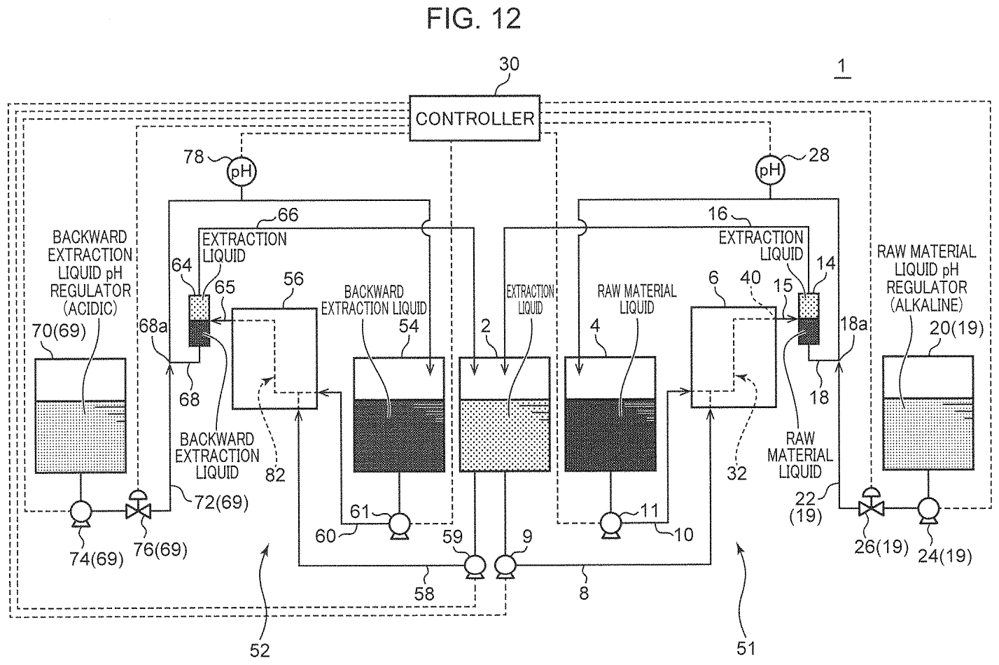

(3) In the backward extraction apparatus 52, the pH regulator addition apparatus 69 may add the backward extraction liquid pH regulator to the backward extraction liquid in the backward extraction liquid return pipe 68. FIG. 12 shows an extraction system 1 according to a third modification to which such a technique is applied.

In the extraction system 1 according to the third modification, the pH regulator supply pipe 72 of the pH regulator addition apparatus 69 is connected to the backward extraction liquid return pipe 68. As a result, through the pH regulator supply pipe 72, the pH regulator for extraction sent from the reservoir unit 70 is added to the backward extraction liquid in the backward extraction liquid return pipe 68. The backward extraction liquid return pipe 68 has a pH regulator addition point 68a, which is connected to the pH regulator supply pipe 72 and serves as a point at which the backward extraction liquid pH regulator is added to the backward extraction liquid in the backward extraction liquid return pipe 68.

In the extraction system 1 according to the third modification, the backward extraction liquid pH sensor 78 is connected to a point on the backward extraction liquid return pipe 68, the point being downstream of the pH regulator addition point 68a in the direction of flow of the backward extraction liquid in the backward extraction liquid return pipe 68, and detects the pH of the backward extraction liquid at that point. Based on the detected pH value from the backward extraction liquid pH sensor 78, the controller 30 causes the flow rate adjusting valve 76 to adjust the flow rate of addition of the backward extraction liquid pH regulator to the backward extraction liquid in the backward extraction liquid return pipe 68. This control of the flow rate adjusting valve 76 by the controller 30 is similar to the control of the flow rate adjusting valve 76 by the controller 30 in the second modification.

The configuration of the extraction system 1 according to the third modification is similar to that of the extraction system 1 according to the second modification, except for the above-described constituent elements.

In the extraction system 1 according to the third modification, the pH of the backward extraction liquid that has been increased by the backward extraction treatment at the backward extractor 56 can be brought closer more quickly to the optimum pH for the backward extraction treatment.

Specifically, when the backward extraction liquid pH sensor 78 detects the pH of the backward extraction liquid in the backward extraction liquid tank 54, the backward extraction liquid pH sensor 78 actually detects the pH of the whole backward extraction liquid in the backward extraction liquid tank 54, the whole backward extraction liquid being obtained when the backward extraction liquid having been subjected to the backward extraction treatment by the backward extractor 56 and flowed through the backward extraction liquid return pipe 68 back to the backward extraction liquid tank 54 joins the backward extraction liquid originally held in the backward extraction liquid tank 54. This pH of the whole backward extraction liquid in the backward extraction liquid tank 54 does not directly reflect a rise in the pH of the backward extraction liquid that is caused by the backward extraction treatment at the backward extractor 56. Therefore, when the controller 30 causes the flow rate adjusting valve 76 to adjust the amount of addition of the backward extraction liquid pH regulator to the backward extraction liquid in the backward extraction liquid return pipe 68, based on this detected pH, the pH of the backward extraction liquid that has been increased by the backward extraction treatment at the backward extractor 56 delays in approaching the optimum pH for the backward extraction treatment. In contrast, in the extraction system 1 according to the third modification, the backward extraction liquid pH sensor 78 detects the pH of the backward extraction liquid in the backward extraction liquid return pipe 68. Therefore, compared with the case of detecting the pH of the backward extraction liquid in the backward extraction liquid tank 54, the backward extraction liquid pH sensor 78 detects the pH of the backward extraction liquid that more directly reflects the rise in the pH of the backward extraction liquid caused by the backward extraction treatment at the backward extractor 56. Hence, based on the detected pH value that more directly reflects the rise in the pH of the backward extraction liquid caused by the backward extraction treatment, the controller 30 causes the flow rate adjusting valve 76 to adjust the amount of addition of the backward extraction liquid pH regulator. Therefore, the pH of the backward extraction liquid that has been increased by the backward extraction treatment can be brought closer more quickly to the optimum pH for the backward extraction treatment.

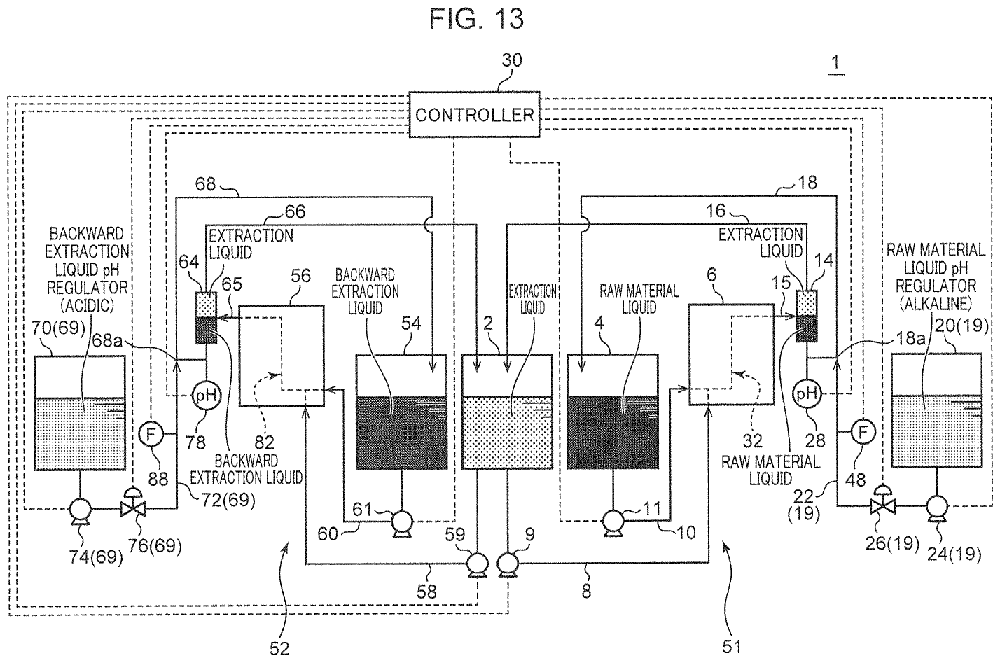

(4) In the configuration in which the pH regulator addition apparatus 69 adds the backward extraction liquid pH regulator to the backward extraction liquid in the backward extraction liquid return pipe 68, the backward extraction liquid pH sensor 78 may detect the pH of the backward extraction liquid at a point on the backward extraction liquid return pipe 68, the point being upstream of the pH regulator addition point 68a in the direction of flow of the backward extraction liquid return pipe 68. FIG. 13 shows an extraction system 1 according to a fourth modification to which such a technique is applied.

In the extraction system 1 according to the fourth modification, the backward extraction liquid pH sensor 78 is connected to a point on the backward extraction liquid return pipe 68, the point being upstream of the pH regulator addition point 68a connected to the pH regulator supply pipe 72, and detects the pH of the backward extraction liquid at that point.

In the extraction system 1 according to the fourth modification, the backward extraction apparatus 52 includes a flowmeter 88 that measures a flow rate of the backward extraction liquid pH regulator flowing through the pH regulator supply pipe 72 toward the pH regulator addition point 68a. The flow rate of the backward extraction liquid pH regulator is an index value for the amount of addition of the backward extraction liquid pH regulator, which is added from the reservoir unit 70 to the backward extraction liquid in the backward extraction liquid return pipe 68. The flow rate of the backward extraction liquid pH regulator is an example of a backward extraction liquid pH regulator index value according to the present invention. The flowmeter 88 is an example of a backward extraction liquid pH regulator index value detector according to the present invention. The flowmeter 88 is connected to a point on the pH regulator supply pipe 72, the point being downstream of the pH regulator supply pump 74 in the direction of flow of the backward extraction liquid pH regulator in the pH regulator supply pipe 72, and successively measures the flow rate of the backward extraction liquid pH regulator at that point to which the flowmeter 88 is connected. The flowmeter 88 successively transmits data of a measurement value of the measured flow rate of the backward extraction liquid pH regulator, to the controller 30.

In the fourth modification, based on the detected pH value of the backward extraction liquid at the point upstream of the pH regulator addition point 68a of the backward extraction liquid return pipe 68, the pH value being detected by the backward extraction liquid pH sensor 78, and on a measurement value of the flow rate of the backward extraction liquid pH regulator, the measurement value being measured by the flowmeter 88, the controller 30 causes the flow rate adjusting valve 76 to adjust the inflow of the backward extraction liquid pH regulator from the pH regulator supply pipe 72 to the pH regulator addition point 68a. The controller 30 carries out this control of the flow rate adjusting valve 76 in the same manner in which the controller 30 of the fifth embodiment causes the flow rate adjusting valve 26 to adjust the inflow of the pH regulator from the pH regulator supply pipe 22 to the pH regulator addition point 18a, based on the detected value detected from the raw material liquid pH sensor 28 and the measurement value measured by the flowmeter 48.

In the fourth modification, the extraction apparatus 51 is similar in configuration to the extraction system 1 according to the fifth embodiment.

The configuration of the extraction system 1 according to the fourth modification is similar to that of the extraction system 1 according to the third modification, except for the above-described constituent elements.

The extraction system 1 according to the fourth modification offers an effect that the pH of the backward extraction liquid that has been increased by the backward extraction treatment at the backward extractor 56 can be brought closer more quickly to the optimum pH for the backward extraction treatment, similar to the extraction system 1 according to the third modification.

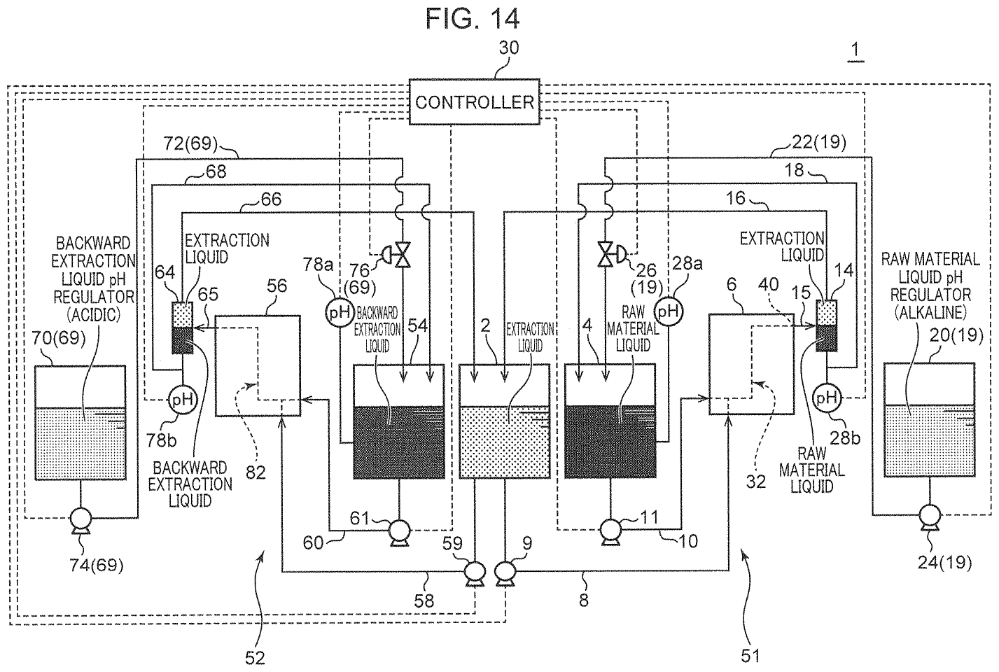

(5) The backward extraction apparatus may be configured to detect the pH value of the backward extraction liquid having the backward extraction liquid pH regulator added thereto but not subjected to the backward extraction treatment at the backward extractor yet, that is, the pH value of the backward extraction liquid not led into the treatment channels in the backward extractor yet, and detect also the pH value of the backward extraction liquid having been subjected to the backward extraction treatment at the backward extractor but not having the backward extraction liquid pH regulator added thereto yet, and to determine whether backward extraction of metal ions from the post-extraction extraction liquid has been completed, based on these detected pH values. FIG. 14 shows an extraction system 1 according to a fifth modification to which such a technique is applied.

The basic configuration of the extraction system 1 according to the fifth modification is similar to that of the extraction system 1 according to the second modification. In the extraction system 1 according to the fifth modification, however, the backward extraction apparatus 52 includes a pre-backward-extraction pH sensor 78a and a post-backward-extraction pH sensor 78b.

The pre-backward-extraction pH sensor 78a detects pH of the backward extraction liquid having the backward extraction liquid pH regulator added thereto by the pH regulator addition apparatus 69 but not subjected to the backward extraction treatment at the backward extractor 56 yet. Specifically, the pre-backward-extraction pH sensor 78a is connected to the backward extraction liquid tank 54, and detects the pH of the backward extraction liquid in the backward extraction liquid tank 54, the backward extraction liquid having the backward extraction liquid pH regulator added thereto by the pH regulator addition apparatus 69. The pre-backward-extraction pH sensor 78a successively detects the pH of the backward extraction liquid in the backward extraction liquid tank 54, and successively transmits data of the detected pH value to the controller 30.

The post-backward-extraction pH sensor 78b detects pH of the backward extraction liquid having been subjected to the backward extraction treatment at the backward extractor 56 but not having the backward extraction liquid pH regulator added thereto by the pH regulator addition apparatus 69 yet. Specifically, the post-backward-extraction pH sensor 78b is connected to the backward extraction liquid return pipe 68. Specifically, the post-backward-extraction pH sensor 78b detects the pH of the backward extraction liquid having been subjected to the backward extraction treatment at the backward extractor 56, separated from the post-backward-extraction extraction liquid by the post-backward-extraction separator 64, and then comes out of the post-backward-extraction separator 64 to flow in the backward extraction liquid return pipe 68. The post-backward-extraction pH sensor 78b successively detects the pH of the backward extraction liquid in the backward extraction liquid return pipe 68, and successively transmits data of the detected pH value to the controller 30.

When a pre-backward-extraction/post-backward-extraction pH difference is larger than a backward extraction liquid pH difference specified value, the pre-backward-extraction/post-backward-extraction pH difference being a pH difference obtained by subtracting the pH of the backward extraction liquid detected by the pre-backward-extraction pH sensor 78a from the pH of the backward extraction liquid detected by the post-backward-extraction pH sensor 78b, the controller 30 causes the post-extraction extraction liquid feed pump 59 and the backward extraction liquid feed pump 61 to keep operating. When the pre-backward-extraction/post-backward-extraction pH difference is equal to or smaller than the backward extraction liquid pH difference specified value, on the other hand, the controller 30 stops the post-extraction extraction liquid feed pump 59 and the backward extraction liquid feed pump 61 from operating. The backward extraction liquid pH difference specified value is a preset value serving as a reference for determining whether backward extraction of metal ions from the post-extraction extraction liquid has been completed, and is a value close to 0.

Until backward extraction of metal ions from the post-extraction extraction liquid is completed, the pH of the backward extraction liquid having been subjected to the backward extraction treatment at the extractor 56 rises from the pH of the backward extraction liquid not subjected to the backward extraction treatment at the extractor 56 yet. When backward extraction of metal ions from the post-extraction extraction liquid is completed, however, the pH of the backward extraction liquid having been subjected to the backward extraction treatment at the extractor 56 hardly changes from the pH of the backward extraction liquid not subjected to the backward extraction treatment at the extractor 56 yet. For this reason, in the fifth modification, the backward extraction liquid pH difference specified value is set close to 0, and the controller 30 determines whether backward extraction of metal ions from the post-extraction extraction liquid has been completed, based on a relationship in size between the pre-backward-extraction/post-backward-extraction pH difference and the backward extraction liquid pH difference specified value.

When the pre-backward-extraction/post-backward-extraction pH difference is larger than the backward extraction liquid pH difference specified value, the controller 30 determines that backward extraction of metal ions from the post-extraction extraction liquid has not been completed yet, and causes the post-extraction extraction liquid feed pump 59 and the backward extraction liquid feed pump 61 to keep operating, thus causing the backward extraction apparatus 52 to continue the backward extraction treatment. When the pre-backward-extraction/post-backward-extraction pH difference is equal to or smaller than the backward extraction liquid pH difference specified value, the controller 30 determines that backward extraction of metal ions from the post-extraction extraction liquid has been completed, and stops the post-extraction extraction liquid feed pump 59 and the backward extraction liquid feed pump 61 from operating, thus causing the backward extraction apparatus 52 to end the backward extraction treatment.

In the fifth modification, the pre-backward-extraction pH sensor 78a serves also as a backward extraction liquid pH sensor that detects the pH of the backward extraction liquid in the backward extraction liquid tank 54, the pH being a reference value based on which the controller 30 causes the flow rate adjusting valve 76 to adjust the inflow of the pH regulator to the backward extraction liquid tank 54. In the extraction system 1 according to the fifth modification, the backward extraction apparatus 52 may include the backward extraction liquid pH sensor and the pre-backward-extraction pH sensor separately as different sensors.

In the fifth modification, the extraction apparatus 51 includes the pre-extraction pH sensor 28a and the post-extraction pH sensor 28b. The pre-extraction pH sensor 28a in the fifth modification is the same as the pre-extraction pH sensor 28a in the first modification. The post-extraction pH sensor 28b in the fifth modification is the same as the post-extraction pH sensor 28b in the first modification. In the fifth modification, as in the first modification, the controller 30 determines whether extraction of metal ions from the raw material liquid is completed, based on the pH of the raw material liquid detected by the pre-extraction pH sensor 28a and the pH of the raw material liquid detected by the post-extraction pH sensor 28b, and controls operations of the raw material liquid feed pump 11 and the extraction liquid feed pump 9.

(6) The backward extraction liquid pH regulator added to the backward extraction liquid may be a solid substance. In this case, the backward extraction liquid pH regulator of a solid substance is an acidic substance soluble in the backward extraction liquid. The solid substance refers to, for example, grains, powder, or flakes of solid substance. In this case, as the backward extraction liquid pH regulator addition apparatus that adds the backward extraction liquid pH regulator of a solid substance to the backward extraction liquid, an apparatus similar to the raw material liquid pH regulator addition apparatus 19 may be adopted. Specifically, as the backward extraction liquid pH regulator addition apparatus, an apparatus may be adopted, which includes a backward extraction liquid pH regulator reservoir unit that is similar to the reservoir unit 42 and that holds the backward extraction liquid pH regulator of a solid substance, a backward extraction liquid pH regulator guide that is similar to the guide 43 and that leads the backward extraction liquid pH regulator of a solid substance discharged from the discharge port of the backward extraction liquid pH regulator reservoir unit, to an addition point at which the backward extraction liquid pH regulator is added to the backward extraction liquid, and a backward extraction liquid pH regulator addition adjusting unit that is similar to the addition adjusting unit 44 and that adjusts the amount of addition of the backward extraction liquid pH regulator of a solid substance, which is added from the backward extraction liquid pH regulator reservoir unit to the backward extraction liquid, to an any given amount of addition.

(7) The pH regulator added to the raw material liquid may be a gaseous substance. The backward extraction liquid pH regulator added to the backward extraction liquid may be a gaseous substance.

(8) The raw material liquid pH regulator may be a dispersion system produced by dispersing a number of particles of solid alkali (powder, grains, or flakes of solid alkali) in a liquid dispersion medium. The backward extraction liquid pH regulator may be a dispersion system produced by dispersing a number of particles of solid acid (powder, grains, or flakes of solid acid) in a liquid dispersion medium.

### Summary of Embodiments and Modifications

The embodiments and the modifications are summarized as follows.

The extraction system according to the embodiments and the modifications is an extraction system which causes an extraction liquid to extract metal ions from a raw material liquid which is an aqueous solution containing the metal ions. This extraction system includes: a raw material liquid tank holding the raw material liquid; an extraction liquid tank holding the extraction liquid; an extractor which is connected to the raw material liquid tank to allow the raw material liquid to be led from the raw material liquid tank into the extractor and which is connected to the extraction liquid tank to allow the extraction liquid to be led from the extraction liquid tank into the extractor, the extractor carrying out an extraction treatment of bringing the raw material liquid led in from the raw material liquid tank into contact with the extraction liquid led in from the extraction liquid tank so that the metal ions are extracted from the raw material liquid to migrate to the extraction liquid; a separator connected to the extractor so as to receive, from the extractor, a mixture liquid of the raw material liquid and the extraction liquid which have been subjected to the extraction treatment, the separator separating the received mixture liquid into the raw material liquid and the extraction liquid; a raw material liquid return path which connects the separator to the raw material liquid tank so as to lead the separated raw material liquid from the separator to the raw material liquid tank, the separated raw material liquid being the raw material liquid separated by the separator; an extraction liquid return path which connects the separator to the extraction liquid tank so as to lead the separated extraction liquid from the separator to the extraction liquid tank, the separated extraction liquid being the extraction liquid separated by the separator; and a raw material liquid pH regulator addition apparatus connected to a raw material liquid pH adjustment place which is one of the raw material liquid tank and the raw material liquid return path, the raw material liquid pH regulator addition apparatus configured to add a raw material liquid pH regulator to the raw material liquid in the raw material liquid pH adjustment place, the raw material liquid pH regulator being a pH regulator which increases pH of the raw material liquid, the pH having been decreased by the extraction treatment.

In this extraction system, the extraction treatment of extracting metal ions from the raw material liquid can be repeatedly carried out solely by the extractor as the raw material liquid and the extraction liquid are circulated, and in every round of the circulation, the raw material liquid pH regulator is added to the raw material liquid to bring the pH of the raw material liquid closer to the optimum pH. Therefore, as an increase in the size and configuration complicity of the extraction system resulting from an increase in the number of the extractors are suppressed, an extraction time in which the pH of the raw material liquid is close to the optimum pH is increased to improve extraction efficiency. In addition, properly changing the number of times of circulating the raw material liquid and the extraction liquid allows flexibly dealing with changes in the metal ion concentration of the raw material liquid not subjected to the extraction treatment yet and properly setting an extraction time required for completing extraction of metal ions from the raw material liquid.

Specifically, in this extraction system, the extractor is connected to the raw material liquid tank so that the raw material liquid from the raw material liquid tank is led into the extractor, and is connected to the extraction liquid tank so that the extraction liquid from the extraction liquid tank is led into the extractor; the separator is connected to the extractor so as to receive, from the extractor, a mixture liquid of the raw material liquid having been subjected to the extraction treatment at the extractor and the extraction liquid subjected to the extraction treatment; the raw material liquid return path connects the separator to the raw material liquid tank so as to lead the raw material liquid separated by the separator, from the separator to the raw material liquid tank; and the extraction liquid return path connects the separator to the extraction liquid tank so as to lead the extraction liquid separated by the separator, from the separator to the extraction liquid tank. In this extraction system, therefore, while the raw material liquid is circulated in such a way as to flow out of the raw material liquid tank, travel through the extractor and the separator, and finally return to the raw material liquid tank, and the extraction liquid is circulated in such a way as to flow out of the extraction liquid tank, travel through the extractor and the separator, and finally return to the extraction liquid tank, the extractor solely carries out the extraction treatment of extracting metal ions from the raw material liquid repeatedly. In addition, the extraction system includes a raw material liquid pH regulator addition apparatus that adds a raw material liquid pH regulator that increases pH of the raw material liquid, the pH having been decreased by the extraction treatment, to the raw material liquid in the raw material liquid pH adjustment place that is one of the raw material liquid tank and the raw material liquid return path. In this extraction system, therefore, every time the raw material liquid circulates in such a way as to flow out of the raw material liquid tank, travel through the extractor and the separator, and finally return to the raw material liquid tank, the raw material liquid pH regulator addition apparatus adds the raw material liquid pH regulator to the raw material liquid in the raw material liquid pH adjustment place to bring the pH of the raw material liquid closer to the optimum pH. Thus, in this extraction system, as an increase in the size and configuration complexity of the extraction system resulting from an increase in the number of the extractors are suppressed, an extraction time in which the pH of the raw material liquid is close to the optimum pH is increased to improve extraction efficiency.

In this extraction system, when the metal ion concentration of the raw material liquid not subjected to the extraction treatment yet is high, the number of times of circulation of the raw material liquid and the extraction liquid is increased to increase the number of times of the extraction treatment by the extractor. This allows a total extraction time in the extraction system to be set as a proper extraction time within which extraction of metal ions from the raw material liquid with a high metal ion concentration is completed. In this extraction system, when the metal ion concentration of the raw material liquid not subjected to the extraction treatment yet is low, the number of times of circulation of the raw material liquid and the extraction liquid is reduced to reduce the number of times of the extraction treatment by the extractor. This allows the total extraction time in the extraction system to be set as a proper extraction time within which extraction of metal ions from the raw material liquid with a low metal ion concentration is completed. Thus, in this extraction system, properly changing the number of times of circulating the raw material liquid and the extraction liquid allows flexibly dealing with changes in the metal ion concentration of the raw material liquid not subjected to the extraction treatment yet and properly setting an extraction time required for completing extraction of metal ions from the raw material liquid.

It is preferable that the raw material liquid pH regulator addition apparatus includes a raw material liquid pH regulator reservoir unit holding the raw material liquid pH regulator; and a raw material liquid pH regulator addition adjusting unit which adjusts an amount of addition of the raw material liquid pH regulator to any given amount, the amount of addition being an amount of addition of the raw material liquid pH regulator added from the raw material liquid pH regulator reservoir unit to the raw material liquid in the raw material liquid pH adjustment place, and that the extraction system further includes a raw material liquid pH sensor that detects pH of one of the raw material liquid in the raw material liquid tank and the raw material liquid in the raw material liquid return path; and a controller that causes the raw material liquid pH regulator addition adjusting unit to adjust an amount of addition of the raw material liquid pH regulator so that a detected pH value of the raw material liquid approaches a raw material liquid pH optimum value set in advance, the detected pH value being pH of the raw material liquid detected by the raw material liquid pH sensor.

According to this configuration, the amount of addition of the raw material liquid pH regulator, which is added from the raw material liquid pH regulator reservoir unit to the raw material liquid in the raw material liquid pH adjustment place, is adjusted so that the detected pH value of the raw material liquid approaches the raw material liquid pH optimum value set in advance, the detected pH value of the raw material being the pH of one of the raw material liquid in the raw material liquid tank and the raw material liquid in the raw material liquid return path. By setting the raw material liquid pH optimum value as the value corresponding to the optimum pH, therefore, the pH of one of the raw material liquid in the raw material liquid tank and the raw material liquid in the raw material liquid return path is adjusted to bring the pH closer to the optimum pH. As a result, the pH of the raw material liquid that is circulated and supplied to the extractor in the above-described manner is brought closer to the optimum pH.

It is preferable that the extraction system further includes a raw material liquid pH regulator index value detector that detects a raw material liquid pH regulator index value which is an index value for an amount of addition of the raw material liquid pH regulator added from the raw material liquid pH regulator reservoir unit to the raw material liquid in the raw material liquid pH adjustment place, in which the controller calculates a necessary amount of regulator addition to the raw material liquid and causes the raw material liquid pH regulator addition adjusting unit to adjust an amount of addition of the raw material liquid pH regulator so that an amount of addition of the raw material liquid pH regulator that corresponds to the raw material liquid pH regulator index value detected by the raw material liquid pH regulator index value detector matches the necessary amount of regulator addition to the raw material liquid, the necessary amount being an amount of addition of the raw material liquid pH regulator that needs to be added to the raw material liquid in order to match the detected pH value of the raw material liquid to the raw material liquid pH optimum value.

According to this configuration, an actual amount of addition of the raw material liquid pH regulator added from the raw material liquid pH regulator reservoir unit to the raw material liquid in the raw material liquid pH adjustment place can be matched to the necessary amount of regulator addition to the raw material liquid. The raw material liquid pH regulator added from the raw material liquid pH regulator reservoir unit to the raw material liquid in the raw material liquid pH adjustment place thus improves the accuracy of raw material liquid pH adjustment for bringing the pH of the raw material liquid closer to the optimum pH.

It is preferable that the raw material liquid pH sensor detects the pH of the raw material liquid in the raw material liquid return path.

According to this configuration, the pH of the raw material liquid that has been decreased by the extraction treatment at the extractor can be brought closer more quickly to the optimum pH. Specifically, if the raw material liquid pH sensor detects the pH of the raw material liquid in the raw material liquid tank, the raw material liquid pH sensor actually detects the pH of the whole raw material liquid in the raw material liquid tank, the whole raw material liquid being obtained when the raw material liquid having been subjected to the extraction treatment at the extractor and then returned to the raw material liquid tank through the raw material liquid return path joins the raw material liquid originally held in the raw material liquid tank. The detected pH value of the whole raw material liquid in the raw material liquid tank, the pH value being detected by the raw material liquid pH sensor, does not directly reflect a drop in the pH of the raw material liquid caused by the extraction treatment at the extractor. When the controller causes the raw material liquid pH regulator addition adjusting unit to adjust the amount of addition of the raw material liquid pH regulator, based on the detected pH value, the pH of the raw material liquid that has been decreased by the extraction treatment at the extractor delays in approaching the optimum pH. According to this configuration, however, the raw material liquid pH sensor detects the pH of the raw material liquid in the raw material liquid return path. Because of this, compared with the case of detecting the pH of the raw material liquid in the raw material liquid tank, the raw material liquid pH sensor detects the pH of the raw material liquid that more directly reflects the drop in the pH of the raw material liquid caused by the extraction treatment at the extractor. The controller, therefore, causes the raw material liquid pH regulator addition adjusting unit to adjust the amount of addition of the raw material liquid pH regulator, based on the detected pH value of the raw material liquid that more directly reflects the drop in the pH of the raw material liquid caused by the extraction treatment at the extractor. Hence the pH of the raw material liquid that has been decreased by the extraction treatment at the extractor can be brought closer more quickly to the optimum pH.

The raw material liquid return path may have a raw material liquid pH regulator addition point connected to the raw material liquid pH regulator addition apparatus, the raw material liquid pH regulator addition point being a point at which the raw material liquid pH regulator addition apparatus adds the raw material liquid pH regulator to the raw material liquid in the raw material liquid return path, and the raw material liquid pH sensor may detect pH of the raw material liquid at a point on the raw material liquid return path, the point being upstream of the raw material liquid pH regulator addition point in a direction of flow of the raw material liquid in the raw material liquid return path.

According to this configuration, the quickness of adjustment of the pH of the raw material liquid that has been decreased by the extraction treatment at the extractor, to the optimum pH, can be further improved. Specifically, in this configuration, the raw material liquid pH sensor detects the pH of the raw material liquid at the point on the raw material liquid return path, the point being upstream of the raw material liquid pH regulator addition point in the direction of flow of the raw material liquid in the raw material liquid return path. In other words, the raw material liquid pH sensor detects the pH of the raw material liquid to which, after a drop in the pH of the raw material liquid caused by the extraction treatment at the extractor, the raw material liquid pH regulator is not added yet and therefore whose pH, which has been decreased, is not restored. In this configuration, therefore, the controller causes the raw material liquid pH regulator addition adjusting unit to adjust the amount of addition of the raw material liquid pH regulator to the raw material liquid, based on the detected pH value of the raw material liquid, the detected pH value being the pH of the raw material liquid detected by the raw material liquid pH sensor. In this case, compared with a case where the raw material liquid pH regulator addition adjusting unit is caused to adjust the amount of addition of the raw material liquid pH regulator to the raw material liquid, based on the detected pH value of the raw material liquid to which the raw material liquid pH regulator has already been added, a greater amount of the raw material liquid pH regulator is added to the raw material liquid, which allows quicker recovery of the pH of the raw material liquid that has been decreased by the extraction treatment at the extractor. Therefore, the quickness of adjustment of the pH of the raw material liquid that has been decreased by the extraction treatment at the extractor, to the optimum pH, can be further improved.

The raw material liquid return path may have a raw material liquid pH regulator addition point connected to the raw material liquid pH regulator addition apparatus, the raw material liquid pH regulator addition point being a point at which the raw material liquid pH regulator addition apparatus adds the raw material liquid pH regulator to the raw material liquid in the raw material liquid return path, and the raw material liquid pH sensor may detect pH of the raw material liquid at a point on the raw material liquid return path, the point being downstream of the raw material liquid pH regulator addition point in a direction of flow of the raw material liquid in the raw material liquid return path.

According to this configuration, at the raw material liquid pH regulator addition point on the raw material liquid return path, the controller causes the raw material liquid pH regulator addition adjusting unit to adjust the amount of addition of the raw material liquid pH regulator, based on the detected pH value of the raw material liquid to which the raw material liquid pH regulator has already been added. As a result, the pH of the raw material liquid that has been decreased by the extraction treatment at the extractor can be adjusted more accurately to the optimum pH.

It is preferable that the extraction system further includes a raw material liquid feed pump that operates to pump the raw material liquid out of the raw material liquid tank and send the raw material liquid to the extractor; an extraction liquid feed pump that operates to pump the extraction liquid out of the extraction liquid tank and send the extraction liquid to the extractor; a pre-extraction pH sensor that detects pH of the raw material liquid having the raw material liquid pH regulator added to the raw material liquid by the raw material liquid pH regulator addition apparatus but not subjected to the extraction treatment at the extractor yet; a post-extraction pH sensor that detects pH of the raw material liquid having been subjected to the extraction treatment at the extractor but not having the raw material liquid pH regulator added to the raw material liquid by the raw material liquid pH regulator addition apparatus yet; and a controller that controls operations of the raw material liquid feed pump and the extraction liquid feed pump, in which when a pre-extraction/post-extraction pH difference is larger than a raw material liquid pH difference specified value set in advance, the controller causes the raw material liquid feed pump and the extraction liquid feed pump to keep operating, and when the pre-extraction/post-extraction pH difference is equal to or smaller than the raw material liquid pH difference specified value, the controller stops the raw material liquid feed pump and the extraction liquid feed pump from operating, the pre-extraction/post-extraction pH difference being a pH difference obtained by subtracting pH of the raw material liquid detected by the post-extraction pH sensor from the pH of the raw material liquid detected by the pre-extraction pH sensor.

Until extraction of metal ions from the raw material liquid is completed, the pH of the raw material liquid having been subjected to the extraction treatment by the extractor drops from the pH of the raw material liquid not subjected to the extraction treatment by the extractor yet. When extraction of metal ions from the raw material liquid is completed, however, the pH of the raw material liquid having been subjected to the extraction treatment by the extractor hardly changes from the pH of the raw material liquid not subjected to the extraction treatment by the extractor yet. For this reason, in this configuration, the raw material liquid pH difference specified value is set close to 0. This allows the controller to determine whether extraction of metal ions from the raw material liquid has been completed, based on a relationship in size between the pre-extraction/post-extraction pH difference and the raw material liquid pH difference specified value. In this configuration, when the pre-extraction/post-extraction pH difference is larger than the raw material liquid pH difference specified value, the controller determines that extraction of metal ions from the raw material liquid is not completed yet, thus causing the raw material liquid feed pump and the extraction liquid feed pump to keep operating to continue the extraction treatment in the extraction system, and when the pre-extraction/post-extraction pH difference is equal to or smaller than the raw material liquid pH difference specified value, the controller determines that extraction of metal ions from the raw material liquid has been completed, thus stopping the raw material liquid feed pump and the extraction liquid feed pump from operating to end the extraction treatment in the extraction system.

It is preferable that the extraction system further includes a backward extraction apparatus connected to the extraction liquid tank, the backward extraction apparatus leading a post-extraction extraction liquid that is the extraction liquid containing the metal ions extracted from the raw material liquid by the extraction treatment, out of the extraction liquid tank, carrying out a backward extraction treatment of bringing the post-extraction extraction liquid into contact with a backward extraction liquid so that the metal ions are extracted from the post-extraction extraction liquid to migrate to the backward extraction liquid, and returning a post-backward-extraction extraction liquid that is the post-extraction extraction liquid subjected to the backward extraction treatment, to the extraction liquid tank.

According to this configuration, the post-extraction extraction liquid, whose metal ion content increases while extraction capability decreases as a result of repetition of the extraction treatment by the extractor, is subjected to the backward extraction treatment by the backward extraction apparatus, which reduces the metal ion content of the post-extraction extraction liquid and restores the extraction capability of the same. The post-backward-extraction extraction liquid, which is the post-extraction extraction liquid with the restored extraction capability, can be returned from the backward extraction apparatus to the extraction liquid tank. According to this configuration, even when the extraction capability of the extraction liquid decreases as a result of repetition of the extraction treatment at the extractor, the extraction capability of the extraction liquid is restored to allow the extractor to carry out the extraction treatment at a fine extraction rate.

It is preferable that the backward extraction apparatus include: a backward extraction liquid tank holding the backward extraction liquid; a backward extractor that is connected to the extraction liquid tank so that the post-extraction extraction liquid from the extraction liquid tank is led into the backward extractor and that is connected to the backward extraction liquid tank so that the backward extraction liquid from the backward extraction liquid tank is led into the backward extractor, the backward extractor carrying out the backward extraction treatment by bringing the post-extraction extraction liquid led in from the extraction liquid tank into contact with the backward extraction liquid led in from the backward extraction liquid tank; a post-backward-extraction separator connected to the backward extractor so as to receive, from the backward extractor, a post-backward-extraction mixture liquid that is a mixture of the post-backward-extraction extraction liquid and the backward extraction liquid that have been subjected to the backward extraction treatment by the backward extractor, the post-backward-extraction separator separating the received post-backward-extraction mixture liquid into the post-backward-extraction extraction liquid and the backward extraction liquid; a post-backward-extraction extraction liquid return path that connects the post-backward-extraction separator to the extraction liquid tank so as to lead the post-backward-extraction extraction liquid separated by the post-backward-extraction separator, from the post-backward-extraction separator to the extraction liquid tank; a backward extraction liquid return path that connects the post-backward-extraction separator to the backward extraction liquid tank so as to lead the backward extraction liquid separated by the post-backward-extraction separator, from the post-backward-extraction separator to the backward extraction liquid tank; and a backward extraction liquid pH regulator addition apparatus connected to a backward extraction liquid pH adjustment place that is one of the backward extraction liquid tank and the backward extraction liquid return path, the backward extraction liquid pH regulator addition apparatus configured to add a backward extraction liquid pH regulator to the backward extraction liquid in the backward extraction liquid pH adjustment place, the backward extraction liquid pH regulator being a pH regulator that decreases pH of the backward extraction liquid, the pH having been increased by the backward extraction treatment.

According to this configuration, the backward extractor solely carries out, in repetition, the backward extraction treatment of backward-extracting metal ions from the post-extraction extraction liquid as the post-extraction extraction liquid and the backward extraction liquid are circulated, and in every cycle of the circulation of both liquids, the backward extraction liquid pH regulator is added to the backward extraction liquid to bring the pH of the backward extraction liquid closer to an optimum pH for the backward extraction treatment. Therefore, compared with a case where the backward extraction apparatus has a plurality of extractors for carrying out the backward extraction treatment, this configuration suppresses an increase in the size and configuration complexity of the extraction system and at the same time, increases a backward extraction treatment time in which the pH of the backward extraction liquid is close to the optimum pH for the backward extraction treatment, thus improving efficiency in carrying out the backward extraction treatment. In addition, according to this configuration, properly changing the number of times of circulation of the post-extraction extraction liquid and the backward extraction liquid allows flexibly dealing with changes in the metal ion content of the post-extraction extraction liquid, thus allowing setting a proper backward extraction treatment time within which backward extraction of metal ions from the post-extraction extraction liquid is completed.

It is preferable that the backward extraction liquid pH regulator addition apparatus includes: a backward extraction liquid pH regulator reservoir unit holding the backward extraction liquid pH regulator; and a backward extraction liquid pH regulator addition adjusting unit that adjusts an amount of addition of the backward extraction liquid pH regulator to any given amount, the amount of addition being an amount of addition of the backward extraction liquid pH regulator added from the backward extraction liquid pH regulator reservoir unit to the backward extraction liquid in the backward extraction liquid pH adjustment place; and that the backward extraction apparatus further includes: a backward extraction liquid pH sensor that detects pH of one of the backward extraction liquid in the backward extraction liquid tank and the backward extraction liquid in the backward extraction liquid return path; and a backward extraction apparatus controller that causes the backward extraction liquid pH regulator addition adjusting unit to adjust an amount of addition of the backward extraction liquid pH regulator so that a detected pH value of the backward extraction liquid approaches a backward extraction liquid pH optimum value set in advance, the detected pH value being pH of the backward extraction liquid detected by the backward extraction liquid pH sensor.

According to this configuration, the amount of addition of the backward extraction liquid pH regulator, which is added from the backward extraction liquid pH regulator reservoir unit to the backward extraction liquid in the backward extraction liquid pH adjustment place, is adjusted so that the detected pH value of the backward extraction liquid approaches a backward extraction liquid pH optimum value set in advance, the detected pH value being detected by the backward extraction liquid pH sensor and being the pH of one of the backward extraction liquid in the backward extraction liquid tank and the backward extraction liquid in the backward extraction liquid return path. Therefore, by setting the backward extraction liquid pH optimum value as the value corresponding to the optimum pH for the backward extraction treatment, the pH of one of the backward extraction liquid in the backward extraction liquid tank and the backward extraction liquid in the backward extraction liquid return path is adjusted to bring the pH closer to the optimum pH for the backward extraction treatment. As a result, the pH of the backward extraction liquid supplied to the backward extractor is brought closer to the optimum pH for the backward extraction treatment by the backward extractor.

It is preferable that the backward extraction apparatus further includes a backward extraction liquid pH regulator index value detector that detects a backward extraction liquid pH regulator index value that is an index value for an amount of addition of the backward extraction liquid pH regulator added from the backward extraction liquid pH regulator reservoir unit to the backward extraction liquid in the backward extraction liquid pH adjustment place; and that the backward extraction apparatus controller calculates a necessary amount of regulator addition to the backward extraction liquid and causes the backward extraction liquid pH regulator addition adjusting unit to adjust an amount of addition of the backward extraction liquid pH regulator so that an amount of addition of the backward extraction liquid pH regulator that corresponds to the backward extraction liquid pH regulator index value detected by the backward extraction liquid pH regulator index value detector matches the necessary amount of regulator addition to the backward extraction liquid, the necessary amount being an amount of addition of the backward extraction liquid pH regulator that needs to be added to the backward extraction liquid in order to match the detected pH value of the backward extraction liquid to the backward extraction liquid pH optimum value.

According to this configuration, an actual amount of addition of the backward extraction liquid pH regulator added from the backward extraction liquid pH regulator reservoir unit to the backward extraction liquid in the backward extraction liquid pH adjustment place can be matched to the necessary amount of regulator addition to the backward extraction liquid. The backward extraction liquid pH regulator added from the backward extraction liquid pH regulator reservoir unit to the backward extraction liquid in the backward extraction liquid pH adjustment place thus improves the accuracy of backward extraction liquid pH adjustment for bringing the pH of the backward extraction liquid closer to the optimum pH for the backward extraction treatment.

It is preferable that the backward extraction liquid pH sensor detects the pH of the backward extraction liquid in the backward extraction liquid return path.

According to this configuration, the pH of the backward extraction liquid that has been increased by the backward extraction treatment at the backward extractor can be brought closer more quickly to the optimum pH for the backward extraction treatment. Specifically, when the backward extraction liquid pH sensor detects the pH of the backward extraction liquid in the backward extraction liquid tank, the backward extraction liquid pH sensor actually detects the pH of the whole backward extraction liquid in the backward extraction liquid tank, the whole backward extraction liquid being obtained when the backward extraction liquid having been subjected to the backward extraction treatment at the backward extractor and then returned to the backward extraction liquid tank through the backward extraction liquid return path joins the backward extraction liquid originally held in the backward extraction liquid tank. This detected pH value of the whole backward extraction liquid in the backward extraction liquid tank, the pH value being detected by the backward extraction liquid pH sensor, does not directly reflect a rise in the pH of the backward extraction liquid that is caused by the backward extraction treatment at the backward extractor. Therefore, when the backward extraction apparatus controller causes the backward extraction liquid pH regulator addition adjusting unit to adjust the amount of addition of the backward extraction liquid pH regulator, based on this detected pH value, the pH of the backward extraction liquid that has been increased by the backward extraction treatment at the backward extractor delays in approaching the optimum pH for the backward extraction treatment. According to this configuration, however, the backward extraction liquid pH sensor detects the pH of the backward extraction liquid in the backward extraction liquid return path. Therefore, in this configuration, compared with the case of detecting the pH of the backward extraction liquid in the backward extraction liquid tank, the backward extraction liquid pH sensor detects the pH of the backward extraction liquid that more directly reflects the rise in the pH of the backward extraction liquid caused by the backward extraction treatment at the backward extractor. Hence, based on the detected pH value of the backward extraction liquid that more directly reflects the rise in the pH of the backward extraction liquid caused by the backward extraction treatment, the backward extraction apparatus controller causes the backward extraction liquid pH regulator addition adjusting unit to adjust the amount of addition of the backward extraction liquid pH regulator. Therefore, the pH of the backward extraction liquid that has been increased by the backward extraction treatment can be brought closer more quickly to the optimum pH for the backward extraction treatment.

The backward extraction liquid return path may have a backward extraction liquid pH regulator addition point connected to the backward extraction liquid pH regulator addition apparatus, the backward extraction liquid pH regulator addition point being a point at which the backward extraction liquid pH regulator addition apparatus adds the backward extraction liquid pH regulator to the backward extraction liquid in the backward extraction liquid return path, and the backward extraction liquid pH sensor may detect the pH of the backward extraction liquid at a point on the backward extraction liquid return path, the point being upstream of the backward extraction liquid pH regulator addition point in the direction of flow of the backward extraction liquid in the backward extraction liquid return path.

According to this configuration, the quickness of adjusting the pH of the backward extraction liquid, which has been increased by the backward extraction treatment at the backward extractor, to the optimum pH for the backward extraction treatment can be further improved. Specifically, in this configuration, the backward extraction liquid pH sensor detects the pH of the backward extraction liquid at the point on the backward extraction liquid return path, the point being upstream of the backward extraction liquid pH regulator addition point in the direction of flow of the backward extraction liquid in the backward extraction liquid return path. In other words, the backward extraction liquid pH sensor detects the pH of the backward extraction liquid to which, after a rise in the pH of the backward extraction liquid caused by the extraction treatment at the extractor, the backward extraction liquid pH regulator is not added yet and therefore whose pH, which has risen, is not restored to a normal one. In this configuration, therefore, the backward extraction apparatus controller causes the backward extraction liquid pH regulator addition adjusting unit to adjust the amount of addition of the backward extraction liquid pH regulator to the backward extraction liquid, based on the detected pH value of the backward extraction liquid, the detected pH value being the pH of the backward extraction liquid detected by the backward extraction liquid pH sensor. In this case, compared with a case where the backward extraction liquid pH regulator addition adjusting unit is caused to adjust the amount of addition of the backward extraction liquid pH regulator to the backward extraction liquid, based on the detected pH value of the backward extraction liquid to which the backward extraction liquid pH regulator has already been added, a greater amount of the backward extraction liquid pH regulator is added to the backward extraction liquid, which allows quicker restoration of the pH of the backward extraction liquid that has been increased by the extraction treatment at the extractor. Therefore, the quickness of adjusting the pH of the backward extraction liquid, which has been increased by the backward extraction treatment at the backward extractor, to the optimum pH for the backward extraction treatment can be further improved.

The backward extraction liquid return path may have a backward extraction liquid pH regulator addition point connected to the backward extraction liquid pH regulator addition apparatus, the backward extraction liquid pH regulator addition point being a point at which the backward extraction liquid pH regulator addition apparatus adds the backward extraction liquid pH regulator to the backward extraction liquid in the backward extraction liquid return path, and the backward extraction liquid pH sensor may detect the pH of the backward extraction liquid at a point on the backward extraction liquid return path, the point being downstream of the backward extraction liquid pH regulator addition point in the direction of flow of the backward extraction liquid in the backward extraction liquid return path.

According to this configuration, at the backward extraction liquid pH regulator addition point on the backward extraction liquid return path, the backward extraction apparatus controller causes the backward extraction liquid pH regulator addition adjusting unit to adjust the amount of addition of the backward extraction liquid pH regulator, based on the detected pH value of the backward extraction liquid to which the backward extraction liquid pH regulator has already been added. Therefore, the pH of the backward extraction liquid that has been increased by the backward extraction treatment can be brought closer more accurately to the optimum pH for the backward extraction treatment.

It is preferable that the backward extraction apparatus further includes: a post-extraction extraction liquid feed pump that operates to pump the post-extraction extraction liquid out of the extraction liquid tank and send the post-extraction extraction liquid to the backward extractor; a backward extraction liquid feed pump that operates to pump the backward extraction liquid out of the backward extraction liquid tank and send the backward extraction liquid to the backward extractor; a pre-backward-extraction pH sensor that detects pH of the backward extraction liquid having the backward extraction liquid pH regulator added to the backward extraction liquid by the backward extraction liquid pH regulator addition apparatus but not subjected to the backward extraction treatment at the backward extractor yet; a post-backward-extraction pH sensor that detects pH of the backward extraction liquid having been subjected to the backward extraction treatment at the backward extractor but not having the backward extraction liquid pH regulator added to the backward extraction liquid by the backward extraction liquid pH regulator addition apparatus yet; and a backward extraction apparatus controller that controls operations of the post-extraction extraction liquid feed pump and the backward extraction liquid feed pump, and that when a pre-backward-extraction/post-backward-extraction pH difference is larger than a backward extraction liquid pH difference specified value set in advance, the backward extraction apparatus controller causes the post-extraction extraction liquid feed pump and the backward extraction liquid feed pump to keep operating, and when the pre-backward-extraction/post-backward-extraction pH difference is equal to or smaller than the backward extraction liquid pH difference specified value, the backward extraction apparatus controller stops the post-extraction extraction liquid pump and the backward extraction liquid feed pump from operating, the pre-backward-extraction/post-backward-extraction pH difference being a pH difference obtained by subtracting pH of the backward extraction liquid detected by the pre-backward-extraction pH sensor from pH of the backward extraction liquid detected by the post-backward-extraction pH sensor.

Until backward extraction of metal ions from the post-extraction extraction liquid is completed, the pH of the backward extraction liquid having been subjected to the backward extraction treatment at the backward extractor rises from the pH of the backward extraction liquid not subjected to the backward extraction treatment at the backward extractor yet. When backward extraction of metal ions from the post-extraction extraction liquid is completed, however, the pH of the backward extraction liquid having been subjected to the backward extraction treatment at the backward extractor hardly changes from the pH of the backward extraction liquid not subjected to the backward extraction treatment at the backward extractor yet. For this reason, in this configuration, setting the backward extraction liquid pH difference specified value as a given value close to 0 allows the backward extraction apparatus controller to determine whether backward extraction of metal ions from the post-extraction extraction liquid has been completed, based on a relationship in size between the pre-backward-extraction/post-backward-extraction pH difference and the backward extraction liquid pH difference specified value. In this configuration, when the pre-backward-extraction/post-backward-extraction pH difference is larger than the backward extraction liquid pH difference specified value, the backward extraction apparatus controller determines that backward extraction of metal ions from the post-extraction extraction liquid is not completed yet, thus causing the post-extraction extraction liquid feed pump and the backward extraction liquid feed pump to keep operating to continue the backward extraction treatment in the backward extraction apparatus, and when the pre-backward-extraction/post-backward-extraction pH difference is equal to or smaller than the backward extraction liquid pH difference specified value, the backward extraction apparatus controller determines that backward extraction of metal ions from the post-extraction extraction liquid has been completed, thus stopping the post-extraction extraction liquid feed pump and the backward extraction liquid feed pump from operating to end the backward extraction treatment in the backward extraction apparatus.

As described above, according to the above embodiments and modifications, an extraction system is provided, which increases an extraction time in which pH of a raw material liquid is close to an optimum pH to improve extraction efficiency while suppressing an increase in the size and configuration complexity of the extraction system, and flexibly deals with changes in a metal ion concentration of the raw material liquid not subjected to an extraction treatment yet to allow properly setting an extraction time required for completing extraction of metal ions from the raw material liquid.

This application is based on Japanese Patent application No. 2020-167650 filed in Japan Patent Office on Oct. 2, 2020, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An extraction system that causes an extraction liquid to extract metal ions from a raw material liquid that is an aqueous solution containing the metal ions, the extraction system comprising:
a raw material liquid tank holding the raw material liquid;
an extraction liquid tank holding the extraction liquid;
an extractor that is connected to the raw material liquid tank to allow the raw material liquid to be led from the raw material liquid tank into the extractor and that is connected to the extraction liquid tank to allow the extraction liquid to be led from the extraction liquid tank into the extractor, the extractor carrying out an extraction treatment of bringing the raw material liquid led in from the raw material liquid tank into contact with the extraction liquid led in from the extraction liquid tank so that the metal ions are extracted from the raw material liquid to migrate to the extraction liquid;
a separator connected to the extractor so as to receive, from the extractor, a mixture liquid of the raw material liquid and the extraction liquid that have been subjected to the extraction treatment, the separator separating the received mixture liquid into the raw material liquid and the extraction liquid;
a raw material liquid return path that connects the separator to the raw material liquid tank so as to lead the separated raw material liquid from the separator to the raw material liquid tank, the separated raw material liquid being the raw material liquid separated by the separator;
an extraction liquid return path that connects the separator to the extraction liquid tank so as to lead the separated extraction liquid from the separator to the extraction liquid tank, the separated extraction liquid being the extraction liquid separated by the separator; and
a raw material liquid pH regulator addition apparatus connected to a raw material liquid pH adjustment place that is one of the raw material liquid tank and the raw material liquid return path, the raw material liquid pH regulator addition apparatus configured to add a raw material liquid pH regulator to the raw material liquid in the raw material liquid pH adjustment place, the raw material liquid pH regulator being a pH regulator that increases pH of the raw material liquid, the pH having been decreased by the extraction treatment.

2. The extraction system according to claim 1, wherein
the raw material liquid pH regulator addition apparatus includes:
a raw material liquid pH regulator reservoir unit holding the raw material liquid pH regulator; and
a raw material liquid pH regulator addition adjusting unit that adjusts an amount of addition of the raw material liquid pH regulator to any given amount, the amount of addition being an amount of addition of the raw material liquid pH regulator added from the raw material liquid pH regulator reservoir unit to the raw material liquid in the raw material liquid pH adjustment place, and
the extraction system further comprises:
a raw material liquid pH sensor that detects pH of one of the raw material liquid in the raw material liquid tank and the raw material liquid in the raw material liquid return path; and
a controller that causes the raw material liquid pH regulator addition adjusting unit to adjust an amount of addition of the raw material liquid pH regulator so that a detected pH value of the raw material liquid approaches a raw material liquid pH optimum value set in advance, the detected pH value being pH of the raw material liquid detected by the raw material liquid pH sensor.

3. The extraction system according to claim 2, further comprising a raw material liquid pH regulator index value detector that detects a raw material liquid pH regulator index value that is an index value for an amount of addition of the raw material liquid pH regulator added from the raw material liquid pH regulator reservoir unit to the raw material liquid in the raw material liquid pH adjustment place,
wherein the controller calculates a necessary amount of regulator addition to the raw material liquid and causes the raw material liquid pH regulator addition adjusting unit to adjust an amount of addition of the raw material liquid pH regulator so that an amount of addition of the raw material liquid pH regulator that corresponds to the raw material liquid pH regulator index value detected by the raw material liquid pH regulator index value detector matches the necessary amount of regulator addition to the raw material liquid, the necessary amount being an amount of addition of the raw material liquid pH regulator that needs to be added to the raw material liquid in order to match the detected pH value of the raw material liquid to the raw material liquid pH optimum value.

4. The extraction system according to claim 2, wherein the raw material liquid pH sensor detects pH of the raw material liquid in the raw material liquid return path.

5. The extraction system according to claim 4, wherein
the raw material liquid return path has a raw material liquid pH regulator addition point connected to the raw material liquid pH regulator addition apparatus, the raw material liquid pH regulator addition point being a point at which the raw material liquid pH regulator addition apparatus adds the raw material liquid pH regulator to the raw material liquid in the raw material liquid return path, and
the raw material liquid pH sensor detects pH of the raw material liquid at a point on the raw material liquid return path, the point being upstream of the raw material liquid pH regulator addition point in a direction of flow of the raw material liquid in the raw material liquid return path.

6. The extraction system according to claim 4, wherein
the raw material liquid return path has a raw material liquid pH regulator addition point connected to the raw material liquid pH regulator addition apparatus, the raw material liquid pH regulator addition point being a point at which the raw material liquid pH regulator addition apparatus adds the raw material liquid pH regulator to the raw material liquid in the raw material liquid return path, and
the raw material liquid pH sensor detects pH of the raw material liquid at a point on the raw material liquid return path, the point being downstream of the raw material liquid pH regulator addition point in a direction of flow of the raw material liquid in the raw material liquid return path.

7. The extraction system according to claim 1, further comprising:
a raw material liquid feed pump that operates to pump the raw material liquid out of the raw material liquid tank and send the raw material liquid to the extractor;
an extraction liquid feed pump that operates to pump the extraction liquid out of the extraction liquid tank and send the extraction liquid to the extractor;
a pre-extraction pH sensor that detects pH of the raw material liquid having the raw material liquid pH regulator added to the raw material liquid by the raw material liquid pH regulator addition apparatus but not subjected to an extraction treatment at the extractor yet;
a post-extraction pH sensor that detects pH of the raw material liquid having been subjected to the extraction treatment at the extractor but not having the raw material liquid pH regulator added to the raw material liquid by the raw material liquid pH regulator addition apparatus yet; and
a controller that controls operations of the raw material liquid feed pump and the extraction liquid feed pump,
wherein when a pre-extraction/post-extraction pH difference is larger than a raw material liquid pH difference specified value set in advance, the controller causes the raw material liquid feed pump and the extraction liquid feed pump to keep operating, and when the pre-extraction/post-extraction pH difference is equal to or smaller than the raw material liquid pH difference specified value, the controller stops the raw material liquid feed pump and the extraction liquid feed pump from operating, the pre-extraction/post-extraction pH difference being a pH difference obtained by subtracting pH of the raw material liquid detected by the post-extraction pH sensor from the pH of the raw material liquid detected by the pre-extraction pH sensor.

8. The extraction system according to claim 1, further comprising a backward extraction apparatus connected to the extraction liquid tank, the backward extraction apparatus leading a post-extraction extraction liquid that is the extraction liquid containing the metal ions extracted from the raw material liquid by the extraction treatment, out of the extraction liquid tank, carrying out a backward extraction treatment of bringing the post-extraction extraction liquid into contact with a backward extraction liquid so that the metal ions are extracted from the post-extraction extraction liquid to migrate to the backward extraction liquid, and returning a post-backward-extraction extraction liquid that is the post-extraction extraction liquid subjected to the backward extraction treatment, to the extraction liquid tank.

9. The extraction system according to claim 8, wherein
the backward extraction apparatus includes:
a backward extraction liquid tank holding the backward extraction liquid;
a backward extractor that is connected to the extraction liquid tank so that the post-extraction extraction liquid from the extraction liquid tank is led into the backward extractor and that is connected to the backward extraction liquid tank so that the backward extraction liquid from the backward extraction liquid tank is led into the backward extractor, the backward extractor carrying out a backward extraction treatment by bringing the post-extraction extraction liquid led in from the extraction liquid tank into contact with the backward extraction liquid led in from the backward extraction liquid tank;
a post-backward-extraction separator connected to the backward extractor so as to receive, from the backward extractor, a post-backward-extraction mixture liquid that is a mixture of the post-backward-extraction extraction liquid and the backward extraction liquid that have been subjected to the backward extraction treatment by the backward extractor, the post-backward-extraction separator separating the received post-backward-extraction mixture liquid into the post-backward-extraction extraction liquid and the backward extraction liquid;
a post-backward-extraction extraction liquid return path that connects the post-backward-extraction separator to the extraction liquid tank so as to lead the post-backward-extraction extraction liquid separated by the post-backward-extraction separator, from the post-backward-extraction separator to the extraction liquid tank;
a backward extraction liquid return path that connects the post-backward-extraction separator to the backward extraction liquid tank so as to lead the backward extraction liquid separated by the post-backward-extraction separator, from the post-backward-extraction separator to the backward extraction liquid tank; and
a backward extraction liquid pH regulator addition apparatus connected to a backward extraction liquid pH adjustment place that is one of the backward extraction liquid tank and the backward extraction liquid return path, the backward extraction liquid pH regulator addition apparatus configured to add a backward extraction liquid pH regulator to the backward extraction liquid in the backward extraction liquid pH adjustment place, the backward extraction liquid pH regulator being a pH regulator that decreases pH of the backward extraction liquid, the pH having been increased by the backward extraction treatment.

10. The extraction system according to claim 9, wherein
the backward extraction liquid pH regulator addition apparatus includes:
a backward extraction liquid pH regulator reservoir unit holding the backward extraction liquid pH regulator; and
a backward extraction liquid pH regulator addition adjusting unit that adjusts an amount of addition of the backward extraction liquid pH regulator to any given amount, the amount of addition being an amount of addition of the backward extraction liquid pH regulator added from the backward extraction liquid pH regulator reservoir unit to the backward extraction liquid in the backward extraction liquid pH adjustment place, and
the backward extraction apparatus further includes:
a backward extraction liquid pH sensor that detects pH of one of the backward extraction liquid in the backward extraction liquid tank and the backward extraction liquid in the backward extraction liquid return path; and
a backward extraction apparatus controller that causes the backward extraction liquid pH regulator addition adjusting unit to adjust an amount of addition of the backward extraction liquid pH regulator so that a detected pH value of the backward extraction liquid approaches a backward extraction liquid pH optimum value set in advance, the detected pH value being pH of the backward extraction liquid detected by the backward extraction liquid pH sensor.

11. The extraction system according to claim 10, wherein
the backward extraction apparatus further includes a backward extraction liquid pH regulator index value detector that detects a backward extraction liquid pH regulator index value that is an index value for an amount of addition of the backward extraction liquid pH regulator added from the backward extraction liquid pH regulator reservoir unit to the backward extraction liquid in the backward extraction liquid pH adjustment place; and
the backward extraction apparatus controller calculates a necessary amount of regulator addition to the backward extraction liquid and causes the backward extraction liquid pH regulator addition adjusting unit to adjust an amount of addition of the backward extraction liquid pH regulator so that an amount of addition of the backward extraction liquid pH regulator that corresponds to the backward extraction liquid pH regulator index value detected by the backward extraction liquid pH regulator index value detector matches the necessary amount of regulator addition to the backward extraction liquid, the necessary amount being an amount of addition of the backward extraction liquid pH regulator that needs to be added to the backward extraction liquid in order to match the detected pH value of the backward extraction liquid to the backward extraction liquid pH optimum value.

12. The extraction system according to claim 10, wherein the backward extraction liquid pH sensor detects pH of the backward extraction liquid in the backward extraction liquid return path.

13. The extraction system according to claim 12, wherein
the backward extraction liquid return path has a backward extraction liquid pH regulator addition point connected to the backward extraction liquid pH regulator addition apparatus, the backward extraction liquid pH regulator addition point being a point at which the backward extraction liquid pH regulator addition apparatus adds the backward extraction liquid pH regulator to the backward extraction liquid in the backward extraction liquid return path, and
the backward extraction liquid pH sensor detects pH of the backward extraction liquid at a point on the backward extraction liquid return path, the point being upstream of the backward extraction liquid pH regulator addition point in a direction of flow of the backward extraction liquid in the backward extraction liquid return path.

14. The extraction system according to claim 12, wherein
the backward extraction liquid return path has a backward extraction liquid pH regulator addition point connected to the backward extraction liquid pH regulator addition apparatus, the backward extraction liquid pH regulator addition point being a point at which the backward extraction liquid pH regulator addition apparatus adds the backward extraction liquid pH regulator to the backward extraction liquid in the backward extraction liquid return path, and
the backward extraction liquid pH sensor detects pH of the backward extraction liquid at a point on the backward extraction liquid return path, the point being downstream of the backward extraction liquid pH regulator addition point in a direction of flow of the backward extraction liquid in the backward extraction liquid return path.

15. The extraction system according to claim 9, wherein
the backward extraction apparatus further includes:
a post-extraction extraction liquid feed pump that operates to pump the post-extraction extraction liquid out of the extraction liquid tank and send the post-extraction extraction liquid to the backward extractor;
a backward extraction liquid feed pump that operates to pump the backward extraction liquid out of the backward extraction liquid tank and send the backward extraction liquid to the backward extractor;
a pre-backward-extraction pH sensor that detects pH of the backward extraction liquid having the backward extraction liquid pH regulator added to the backward extraction liquid by the backward extraction liquid pH regulator addition apparatus but not subjected to the backward extraction treatment at the backward extractor yet;
a post-backward-extraction pH sensor that detects pH of the backward extraction liquid having been subjected to the backward extraction treatment at the backward extractor but not having the backward extraction liquid pH regulator added to the backward extraction liquid by the backward extraction liquid pH regulator addition apparatus yet; and
a backward extraction apparatus controller that controls operations of the post-extraction extraction liquid feed pump and the backward extraction liquid feed pump, and
when a pre-backward-extraction/post-backward-extraction pH difference is larger than a backward extraction liquid pH difference specified value set in advance, the backward extraction apparatus controller causes the post-extraction extraction liquid feed pump and the backward extraction liquid feed pump to keep operating, and when the pre-backward-extraction/post-backward-extraction pH difference is equal to or smaller than the backward extraction liquid pH difference specified value, the backward extraction apparatus controller stops the post-extraction extraction liquid feed pump and the backward extraction liquid feed pump from operating, the pre-backward-extraction/post-backward-extraction pH difference being a pH difference obtained by subtracting pH of the backward extraction liquid detected by the pre-backward-extraction pH sensor from pH of the backward extraction liquid detected by the post-backward-extraction pH sensor.
